(19) United States
(12) Patent Application Publication
(10) Pub. No.: US 2025/0278009 A1
(43) Pub. Date: Sep. 4, 2025

(54) HETEROGENEOUS INTEGRATION OF LIGHT EMITTING AND NONLINEAR SEMICONDUCTOR DEVICES AND RELATED INTRACAVITY STRUCTURES FOR OPTICAL RADIATION IN FAR-UVC SPECTRUM

(71) Applicant: Uviquity, Inc., Raleigh, NC (US)

(72) Inventors: Brent Fisher, Bethesda, MD (US); James Carter, Chapel Hill, NC (US); Scott Burroughs, Raleigh, NC (US)

(21) Appl. No.: 19/212,075

(22) Filed: May 19, 2025

Related U.S. Application Data
(63) Continuation-in-part of application No. 18/837,695, filed on Aug. 12, 2024.
(60) Provisional application No. 63/649,851, filed on May 20, 2024.
(60) Provisional application No. 63/359,251, filed on Jul. 8, 2022.
(60) Provisional application No. 63/311,660, filed on Feb. 18, 2022.

(51) Int. Cl. G02F 1/35; G02F 1/355; G02F 1/37

(52) U.S. Cl. CPC G02F 1/3503; G02F 1/3534; G02F 1/3556; G02F 1/37; G02F 2203/15

(57) ABSTRACT

A semiconductor light source includes a substrate, a light emitting element comprising a first semiconductor material on the substrate, and a nonlinear optical element comprising a second semiconductor material, which is different from the first semiconductor material, on the substrate. The light emitting element is configured to generate light of a first frequency, and the nonlinear optical element is configured to receive the light of the first frequency from the light emitting element and generate light of a second frequency. The substrate is native to one of the first semiconductor material or the second semiconductor material. Related devices and fabrication methods are also discussed.

### CLAIM OF PRIORITY

This application claims priority from U.S. Provisional Patent Application No. 63/649,851, filed May 20, 2024 in the United States Patent and Trademark Office, the disclosure of which is incorporated by reference herein in its entirety. This application is also a continuation in part of U.S. patent application Ser. No. 18/837,695, filed Aug. 12, 2024 in the United States Patent and Trademark Office, which is a 35 U.S.C. § 371 national stage application of PCT Application No. PCT/US2023/013187, filed Feb. 16, 2023, which claims priority from U.S. Provisional Patent Application No. 63/311,660 filed Feb. 18, 2022, and U.S. Provisional Patent Application No. 63/359,251 filed Jul. 8, 2022, with the United States Patent and Trademark Office, the disclosures of which are incorporated by reference herein in their entireties.

### FIELD

The present application is directed to UV light sources, and in particular, to far-UVC light sources and related devices and methods.

### BACKGROUND

Compact and efficient ultraviolet (UV) light sources in the wavelength range of about 200 nanometers (nm) to about 400 nm may be desirable for many applications. For example, UV lasers may be used for lithography in semiconductor manufacturing. Another application is the detection and classification of materials and substances, such as in mass spectroscopy. Photons in the UV-C (or UVC) wavelength range (e.g., about 200 nm to about 280 nm) can be used to disinfect airborne and surface disease-causing pathogens, while photons in the far end of the UVC wavelength range (also referred to as far-UVC light) may be safe for human exposure. For example, far-UVC light (from about 200 nm to about 240 nm, e.g., 200 nm to 230 nm) may not penetrate through the dead-cell layer of the skin surface or the tear layer of the human eye, but may be effective against bacteria and viruses. In particular, far-UVC light can efficiently cause permanent physical damage to DNA and proteins, which can prevent bacteria, viruses and fungi from replicating. Human-safe far-UVC light can thus effectively kill disease causing pathogens with little to no risk to humans because these wavelengths may be largely absorbed by the stratum corneum (the top layer of dead skin cells in the epidermis).

However, operation in the far-UVC wavelength range may present challenges. For example, few available light sources may be configured for operation in the far-UV. Semiconductor-based LED light sources (e.g., based on GaN material system) have been used to provide UV light, for example, using phosphor-based wavelength conversion. Such light sources typically have short operating lifetimes and poor performance at emission wavelengths shorter than about 265 nm, and wide band (>5-10 nm bandwidth) emission making it even more challenging to move the emitted wavelengths into the far-UVC.

### SUMMARY

According to some embodiments, a light source includes a substrate; a light emitting element comprising a first semiconductor material on the substrate, wherein the light emitting element is configured to generate light of a first frequency; and a nonlinear optical element comprising a second semiconductor material on the substrate. The nonlinear optical element is configured to receive the light of the first frequency from the light emitting element and generate light of a second frequency. The second semiconductor material is different from the first semiconductor material, and wherein the substrate is native to one of the first semiconductor material or the second semiconductor material.

In some embodiments, the light source further includes a waveguide element comprising a material different than the first semiconductor material on a surface of the substrate, where the waveguide element optically couples the light emitting element to the nonlinear optical element.

In some embodiments, the nonlinear optical element comprises one or more epitaxial layers of the second semiconductor material on the surface of the substrate.

In some embodiments, the substrate comprises a recess therein, where the light emitting element is in the recess, and the waveguide element is on the surface of the substrate outside the recess.

In some embodiments, the substrate is a first substrate, and the light source further includes a second substrate having the first substrate stacked thereon. The recess extends through the first substrate to expose a portion of the second substrate, and the light emitting element is on the portion of the second substrate exposed by the recess.

In some embodiments, first portions of the waveguide element are between the light emitting element and the surface of the substrate in a vertical direction.

In some embodiments, the nonlinear optical element is between second portions of the waveguide element and the surface of the substrate in the vertical direction.

In some embodiments, the first portions of the waveguide element comprise the second semiconductor material.

In some embodiments, the waveguide element comprises a material that is different from the second semiconductor material and is transparent to the light of the second frequency.

In some embodiments, the light emitting element comprises one or more epitaxial layers of the first semiconductor material on the surface of the substrate.

In some embodiments, one or more portions of the waveguide element are between the nonlinear optical element and the surface of the substrate.

In some embodiments, the nonlinear optical element comprises one or more epitaxial layers of the second semiconductor material on at least a portion of a growth substrate.

In some embodiments, the substrate comprises a recess therein, and the at least a portion of the growth substrate is in the recess.

In some embodiments, the waveguide element is configured for light propagation in a first plane that differs from a second plane of light propagation in the light emitting element or the nonlinear optical element. The light source further includes one or more tapered optical elements configured to direct the light of the first frequency or the light of the second frequency between the first plane and the second plane.

In some embodiments, the light emitting element is a laser diode comprising a lasing cavity, and wherein the nonlinear optical element comprises a resonant cavity that is optically coupled to the lasing cavity.

According to some embodiments, a light source includes a substrate; a laser diode comprising a first semiconductor material on the substrate, wherein the laser diode comprises a lasing cavity and is configured to generate light of a first frequency; a waveguide element comprising a material different from the first semiconductor material on the substrate, where the waveguide element is at least partially between first and second ends of the lasing cavity and is configured to receive the light of the first frequency from the laser diode; and a nonlinear optical element comprising a second semiconductor material different from the first semiconductor material on the substrate, where the nonlinear optical element comprises a resonant cavity that is optically coupled between the first and second ends of the lasing cavity and is configured to receive the light of the first frequency from the waveguide element and generate light of a second frequency.

In some embodiments, the waveguide element comprises respective reflector elements at the first and second ends of the lasing cavity, and the nonlinear optical element comprises a closed-loop element comprising the resonant cavity.

In some embodiments, the laser diode is configured to emit the light of the first frequency in a first propagation direction that is different from a plane of extension of the waveguide element, and the light source further includes a diffraction grating that is configured to alter the first propagation direction of the light of the first frequency into a second propagation direction along the plane of the waveguide element.

In some embodiments, a phase tuning element is included in the lasing cavity and is configured to alter an index of refraction of the waveguide element.

In some embodiments, the substrate is native to one of the first semiconductor material or the second semiconductor material.

According to some embodiments, a method of fabricating a semiconductor light source includes providing a substrate; providing a light emitting element comprising a first semiconductor material on the substrate, where the light emitting element is configured to generate light of a first frequency; and providing a nonlinear optical element comprising a second semiconductor material on the substrate, where the nonlinear optical element is configured to receive the light of the first frequency from the light emitting element and generate light of a second frequency. The second semiconductor material is different from the first semiconductor material, and the substrate is native to one of the first semiconductor material or the second semiconductor material.

In some embodiments, the method further includes providing a waveguide element material, which is different than the first semiconductor material, on a surface of the substrate; and patterning the waveguide element material to form a waveguide element on the surface of the substrate, where the waveguide element optically couples the light emitting element to the nonlinear optical element.

In some embodiments, providing the nonlinear optical element includes epitaxially growing the second semiconductor material on the surface of the substrate; and patterning the second semiconductor material to form the nonlinear optical element on the surface of the substrate.

In some embodiments, providing the light emitting element on the substrate includes patterning the substrate to form a recess therein; and providing the light emitting element in the recess, where the waveguide element and the nonlinear optical element are on the surface of the substrate outside the recess.

In some embodiments, providing the light emitting element in the recess and providing the nonlinear optical element include bonding the first semiconductor material in the recess; and patterning the first semiconductor material and the second semiconductor material to define the light emitting element in the recess and the nonlinear optical element on the surface of the substrate outside the recess.

In some embodiments, the substrate is a first substrate, and providing the light emitting element in the recess includes thinning the first substrate; bonding second substrate to the first substrate responsive to the thinning, where the recess extends through the first substrate to expose a portion of the second substrate; and providing the light emitting element on the portion of the second substrate exposed by the recess.

In some embodiments, the light emitting element is provided on one or more portions of the waveguide element such that the one or more portions of the waveguide element are between the light emitting element and the surface of the substrate in a vertical direction.

In some embodiments, the one or more portions of the waveguide element comprise the second semiconductor material.

In some embodiments, the waveguide element material is different from the second semiconductor material and is transparent to the light of the second frequency.

In some embodiments, providing the light emitting element includes transfer printing the first semiconductor material onto the waveguide element.

In some embodiments, providing the light emitting element includes epitaxially growing the first semiconductor material on a surface of the substrate; and patterning the first semiconductor material to form the light emitting element on the surface of the substrate.

In some embodiments, the substrate is a first substrate, and providing the nonlinear optical element includes epitaxially growing the second semiconductor material on a second substrate; and bonding the second substrate to the first substrate.

In some embodiments, providing the nonlinear optical element further includes at least partially removing the second substrate after the bonding to the first substrate; and patterning the second semiconductor material to form the nonlinear optical element on one or more portions of the waveguide element.

In some embodiments, providing the nonlinear optical element includes patterning the first substrate to form a recess therein; and bonding the second substrate including the second semiconductor material thereon in the recess in the first substrate, where the waveguide element is on the surface of the first substrate outside the recess.

In some embodiments, the light emitting element is a laser diode comprising a lasing cavity, and wherein the nonlinear optical element comprises a resonant cavity that is optically coupled to the lasing cavity.

In some embodiments, providing the waveguide element includes forming respective reflector elements at the first and second ends of the lasing cavity, where the nonlinear optical element comprises a closed loop element comprising the resonant cavity.

In some embodiments, the laser diode is configured to emit the light of the first frequency in a first propagation direction that is different from a plane of extension of the waveguide element. The method further includes providing a diffraction grating in or on the waveguide element, where the diffraction grating is configured to alter the first propagation direction of the light of the first frequency into a second propagation direction along the plane of the waveguide element.

In some embodiments, a phase tuning element is provided in the lasing cavity and is configured to alter an index of refraction of the waveguide element.

In some embodiments, the waveguide element is configured for light propagation in a first plane that differs from a second plane of light propagation in the light emitting element or the nonlinear optical element. The method further includes providing one or more tapered optical elements configured to direct the light of the first frequency or the light of the second frequency between the first plane and the second plane.

In some embodiments, the second semiconductor material comprises aluminum nitride (AlN), and the first semiconductor material comprises a Group III nitride.

Other devices, apparatus, and/or methods according to some embodiments will become apparent to one with skill in the art upon review of the following drawings and detailed description. It is intended that all such additional embodiments, in addition to any and all combinations of the above embodiments, be included within this description, be within the scope of the invention, and be protected by the accompanying claims.

### BRIEF DESCRIPTION OF THE DRAWINGS

FIGS. 1A, 1B, 1C, 1D, and 1E are perspective view schematic diagrams illustrating example light source configurations that integrate one or more optical components, which may be used in some embodiments of the present disclosure.

FIGS. 2A, 2B, and 2C are schematic diagrams illustrating hybrid implementations of diffraction gratings for tuning laser output wavelength range.

FIGS. 3A, 3B, 3C, and 3D are schematic diagrams illustrating examples of hybrid integration of an external cavity laser that emits light into a second harmonic generating (SHG) waveguide.

FIGS. 4A, 4B, and 4C are schematic diagrams illustrating examples of hybrid integration of an external cavity laser that emits light into an intracavity resonant SHG waveguide.

FIGS. 5 and 6 are plan view schematic diagrams illustrating examples of a light source or light emitting device including heterogeneous integration of a laser with an intracavity nonlinear optical element according to some embodiments of the present disclosure.

FIGS. 7 and 8 are plan view schematic diagrams illustrating additional examples of a light source or light emitting device including heterogeneous integration of a laser with an intracavity nonlinear optical element according to some embodiments of the present disclosure.

FIG. 9 is a side or cross-sectional view schematic diagram illustrating integration of a light emitting element in a recess in a native substrate on which a nonlinear optical material is formed, according to some embodiments of the present disclosure.

FIG. 10 is a side or cross-sectional view schematic diagram illustrating integration of a light emitting element in a recess in a native substrate on which a nonlinear optical material is formed, according to some embodiments of the present disclosure.

FIG. 11 is a side or cross-sectional view schematic diagram illustrating integration of a light emitting element and a nonlinear optical element into respective recesses in a non-native substrate, according to some embodiments of the present disclosure.

FIG. 12 is a side or cross-sectional view schematic diagram illustrating integration of a light emitting element onto a waveguide material on a surface of a native substrate on which a nonlinear optical material is formed, according to some embodiments of the present disclosure.

FIG. 13 is a side or cross-sectional view schematic diagram illustrating integration of a light emitting element onto a nonlinear optical material on a surface of a native substrate, according to some embodiments of the present disclosure.

FIG. 14 is a side or cross-sectional view schematic diagram illustrating integration of a light emitting element and a nonlinear optical element onto a waveguide material on a surface of a substrate, according to some embodiments of the present disclosure.

FIG. 15 is a side or cross-sectional view schematic diagram illustrating integration of a light emitting element and a patterned nonlinear optical element onto a waveguide material on a surface of a substrate, according to some embodiments of the present disclosure.

FIG. 16 is a side or cross-sectional view schematic diagram illustrating integration of a nonlinear optical element onto a waveguide material on a native substrate on which a light emitting element is formed, according to some embodiments of the present disclosure.

FIG. 17 is a side or cross-sectional view schematic diagram illustrating integration of a nonlinear optical material onto a waveguide material on a native substrate on which a light emitting element is formed, with evanescent coupling of the light between the waveguide material and the nonlinear optical material, according to some embodiments of the present disclosure.

FIG. 18 is a side or cross-sectional view schematic diagram illustrating integration of a nonlinear optical material into a recess or pocket of a native substrate on which a light emitting element is formed, with edge coupling of the light between the waveguide material and the nonlinear optical material, according to some embodiments of the present disclosure.

FIG. 19 is a side or cross-sectional view schematic diagram illustrating integration of light emitting device materials onto a surface of a native substrate of a nonlinear optical element using transfer printing, according to some embodiments of the present disclosure.

FIGS. 20, 21, and 22 are side or cross-sectional view schematic diagrams illustrating integration of a light emitting element and a nonlinear optical element onto a non-native substrate using transfer printing, according to some embodiments of the present disclosure.

### DETAILED DESCRIPTION OF EMBODIMENTS

Embodiments of the present disclosure allow generation of light in the far-UVC band using compact light sources based on materials and processes from the semiconductor industry, which allows rapid volume scaling and reduction of cost that may not be available by other methods. Some embodiments of the present disclosure may provide a far-UVC light source including a semiconductor light emitting element, such as a pump laser (e.g., a Group-Ill nitride-based laser diode or other Group III-V-based light emitting element) configured to generate light of a first wavelength or frequency (e.g., in the visible spectrum, also referred to herein as visible light), which is coupled (or “pumped”) into a nonlinear optical (NLO) element (e.g., an integrated waveguide with nonlinear optical properties) for generation of light of a second wavelength or frequency. The light of the second wavelength or frequency may be a sum of the frequency or frequencies of the light of the first wavelength (also referred to herein as sum frequency generation (SFG), e.g., Second Harmonic Generation (SHG) or frequency doubled light). Sum frequency generation may include both frequency doubling (combination of photons of the same wavelength) and optical parametric conversion (i.e., from combination or difference of two photons of unequal wavelength). The nonlinear optical element may be referred to herein as an SHG element, or more generally, an SFG element. The sum frequency generation or frequency-doubling converts a portion of the visible light emitted by the light emitting element 110 into far-UVC light. The term wavelength converter element (or simply “wavelength converter”) may be used herein to generally refer to nonlinear optical elements, SFG elements, and SHG elements.

Second (or third, fourth, etc.) harmonic frequency generation using nonlinear optical materials in accordance with some embodiments may utilize several components or characteristics for efficient conversion. For example, a nonlinear crystal that is non-centrosymmetric and highly polarizable may lead to non-zero elements of its second order non-linearity tensor, where the higher this coefficient, the higher the conversion rate. The nonlinear crystal should be at least partially optically transparent at the wavelength of the frequency doubled light (as otherwise the crystal may absorb the newly generated light). Also, a pump light source that is coherent (as second harmonic generation is a coherent effect relevant to a single wavelength, so the pump laser may have a narrow linewidth with sufficiently long coherence length) and high power (as the output power of second harmonic generation scales with the square of the pump power; therefore the higher the power of the pump laser the higher the efficiency of conversion) may be used. In some embodiments, pulsed lasers, which generally have higher peak pulse power than continuous wave (CW) lasers, may be preferred. In some embodiments, phase matching methods may be used to match the phase speed of the pump wavelength to that of the second harmonic wavelength such that coherent addition of the electric field from both waves is maintained over some or all of the propagation length of the nonlinear crystal as may improve efficiency. Laser diodes as described herein may be generally referred to herein as lasers.

Some embodiments of the present disclosure provide a solid-state Far UV Photonic Integrated Circuits (PIC) (for example, based upon the AlN/AlScN/AlGaN material system), which may be scalable to high volumes, low cost, high WPE, and small form factors without the need for an optical filter that discriminates or transmits light only within a range of far-UVC wavelengths. Some embodiments integrate active and passive components on the same chip (e.g., using components of the same material systems, such as nitride based materials) such that the optical losses between devices are reduced or minimized. In addition, some embodiments of the present disclosure may specifically target conversion from approximately 440 nm into approximately 220 nm (e.g., from 400-460 nm into 200-230 nm, such as from 444 nm into 222 nm) with a focus on conversion efficiency, in contrast to designs that may attempt to fabricate coherent, polarized laser (beams) with narrow linewidth, high collimation or other attributes than efficiency. Also, PICs in accordance with some embodiments may leverage resonant cavity enhancement (in some instances, with intracavity SHG elements) to increase or maximize the intensity of the fundamental wave and thus increase or maximize efficiency. The output light provided by embodiments of the present disclosure may be collimated or non-collimated, coherent or incoherent, and emitted as a beam or as distributed emission.

As used herein, a hybrid structure or hybrid integration may refer to arrangement of separate or discrete functional elements (e.g., respective light emitting and wavelength converting semiconductor elements, i.e. respective light emitting and wavelength converting semiconductor chips) on a non-native substrate (i.e., a substrate that is different from the native or source substrate on which at least one of the elements (or materials thereof) are grown or otherwise formed). Hybrid integration connects two or more PIC or photonic device chips (e.g., from different material technologies) into a single package. Hybrid integration may generally be performed at the packaging stage, after the fabrication of the PIC and photonic device chips. That is, hybrid integration may join two or more individual completed and tested photonic chips, each independent of each other, onto a substrate or platform as part of a photonic packaging process (for example, by attaching discrete photodetectors, lasers, and modulators together in an optical train to form a hybrid photonic circuit within an optoelectronic package).

Other structures may involve homogeneous and/or heterogeneous integration into a single chip or block of semiconductor material. Homogeneous integration may refer to the fabrication of a single photonic integrated circuit chip using semiconductor materials that are grown onto a single native substrate in one or more growth steps to form a photonic integrated circuit including two or more active and passive devices. Heterogeneous integration may refer to an integration process that combines two or more material technologies into a single PIC chip. Heterogeneous integration may generally be performed at the early-to mid-stages of fabrication of the PIC chip, for example, unpatterned III-V thin-films integrated onto pre-processed photonic wafers.

That is, heterogeneous integration may join two or more dissimilar semiconductor optical materials or structures, which are subsequently processed to form a single photonic integrated circuit chip including two or more active and passive devices. Heterogeneous integration may refer to any arrangement of active elements and/or passive elements of different materials, which may be coupled to one another on a native (e.g., growth) substrate or on a non-native substrate. The dissimilar materials may be formed by epitaxial growth on separate substrates and subsequently joined together using micro-transfer printing, wafer bonding, flip chip bonding, die-to-wafer joining, direct bonding, or other forms of mass transfer for solid state integration. Solid state integration may refer to any arrangement of active elements (e.g., light emitting element 110s) and/or passive elements (e.g., waveguides or other optical coupling elements) in a unitary structure, with no air interfaces or free propagation of light between elements longer than 5-10× the wavelength.

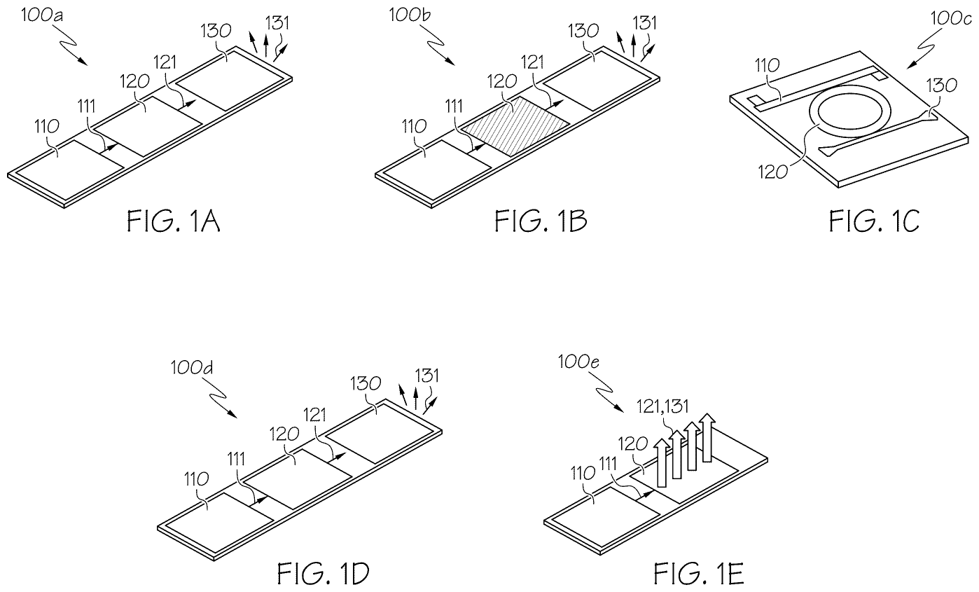

FIGS. 1A to 1E illustrate example configurations of UV light sources based on integration of one or more components. UV light sources are also described in PCT Application No. PCT/US2023/013187 entitled NONLINEAR SOLID STATE DEVICES FOR OPTICAL RADIATION IN FAR-UVC SPECTRUM, filed Feb. 16, 2023, the disclosure of which is incorporated by reference herein. As shown in FIGS. 1A to 1E, the UV light sources 100a, 110b, 100c, 100d, and 100e each include a light emitting element 110 (e.g., a Group-III nitride-based laser diode, such as a blue pump laser diode) configured to generate light 111 of a first (fundamental) frequency or wavelength (e.g., visible light); a nonlinear optical element 120 (e.g., a nonlinear optical crystal, such as a SFG element, which may be implemented as a frequency doubling waveguide) that is optically transparent to wavelengths at or below the desired output wavelength (e.g., the UVC wavelength range of about 200 nm to about 280 nm, or the far-UVC wavelength range of about 200 nm to about 240 nm) and is configured to generate light 121 of a second frequency or wavelength (e.g., UVC or far-UVC light) based on sum frequency generation of the light 111 of the first frequency; an input coupling element (such as a waveguide) configured to couple the light 111 from the light emitting element 110 into the nonlinear optical element 120; and an output coupling element 130 configured to selectively or non-selectively outcouple the light 121 of the second frequency or wavelength from the nonlinear optical element 120 as output light 131.

In particular, the light source 100a of FIG. 1A illustrates an example of monolithic or solid state integration of a light emitting element 110, a nonlinear optical element 120, and an output coupling element 130 in unitary structure. The light source 100b of FIG. 1B further illustrates heterogeneous integration of a light emitting element 110 and a nonlinear optical element 120 of different materials, for example, a Group-III nitride-based laser diode 110 and an AlN-based nonlinear optical element 120. The light source 100c of FIG. 1C illustrates implementation of the nonlinear optical element 120 (shown as a ring resonator) coupled between ends of the lasing cavity of the laser diode 110, also referred to herein as an intracavity arrangement. The light source 100d of FIG. 1D illustrates configuration of the output coupling element 130 to provide selective light extraction, for example, such that a desired frequency or wavelength of the light 121 (e.g., 220 nm) is preferentially outcoupled as the output light 131, while the fundamental frequency or wavelength of the light 111 (e.g., 440 nm) is attenuated or blocked. The light source 100e of FIG. 1E illustrates configuration of the nonlinear optical element 120 and the output coupling element 130 to provide distributed light emission, in which light (e.g., the far-UVC light 121) is continuously or semi-continuously extracted as it is generated at multiple positions along the length of the nonlinear optical element 120 (rather than from one specific point or position), for example using one or more diffraction gratings or reflectors, which may avoid or mitigate phase matching requirements. The output coupling element 130 may thereby be configured to output the light 121, 131 in one or more directions that differ from a direction of propagation of the pump light 111. In some embodiments, one or more elements may be configured to provide phase matching between the light 121 of the second frequency and the fundamental frequency of the pump light 111.

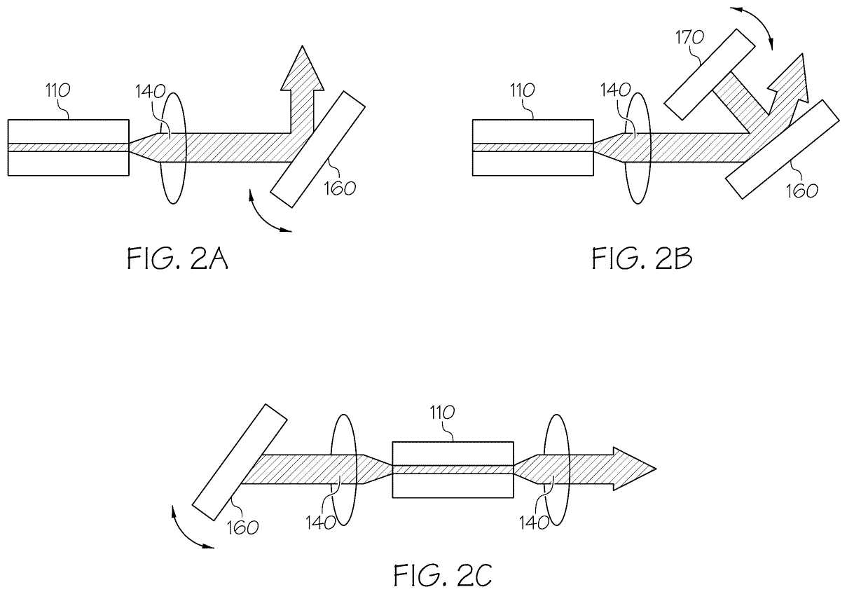

FIGS. 2A to 2C illustrate different hybrid implementations that use diffraction gratings 160 (along with one or more lenses 140 or mirrors 170) for tuning (or narrowing) the output wavelength range of the light emitted by the laser diode 110. In particular, the laser output wavelength range may be tuned or narrowed based on rotation of the grating 160, as shown in FIG. 2A; based on rotation of an additional mirror 170, as shown in FIG. 2B; and based on implementation of an additional lens 140, as shown in FIG. 2C.

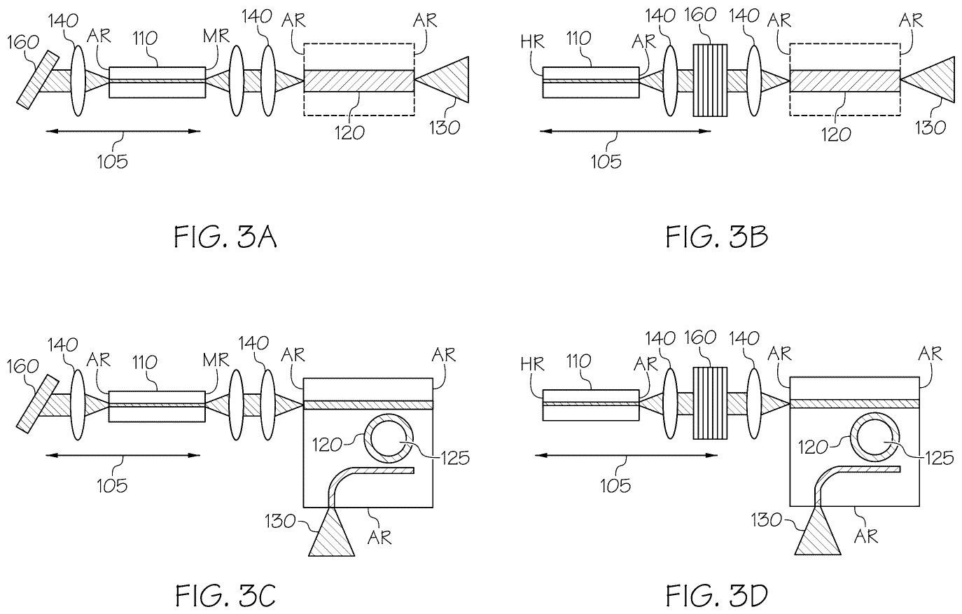

FIGS. 3A to 3D are schematic diagrams illustrating examples of hybrid integration of an external cavity laser diode 110 that emits light into nonlinear optical element 120 implemented as a second harmonic generating (SHG) waveguide. The laser diode 110 may include a lasing cavity 105 and facet coatings (e.g., highly reflective HR, or anti-reflective AR), with the nonlinear optical element 120 provided outside of the lasing cavity 105 (also referred to herein as an external cavity laser). In particular, FIGS. 3A and 3B illustrate example designs based on hybrid integration of an external cavity laser diode 110 pumping a single pass SHG waveguide 120, with a third component medium (including lenses 140 and/or diffraction gratings 160) therebetween for chip-to-chip transfer of light. To achieve efficient frequency conversion, high pump field intensities may be required. As shown in FIGS. 3C and 3D, nonlinear optical elements 120 implemented as resonant cavity structures 125 (e.g., ring resonators) may help to achieve high intensities. That is, FIGS. 3C and 3D illustrate example designs based on hybrid integration of an external cavity laser pumping a resonant SHG waveguide 120 with one or more lenses 140 therebetween.

There may be challenges, however, in keeping the frequency of the pump laser diode or other light emitting element 110 well matched to the resonant frequency of the nonlinear optical element 120, which functions as the wavelength converter. In particular, for optimal efficiency, the bandwidth of the laser emission should be equal to or narrower than the bandwidth of the resonant cavity 125 used to enhance SFG. The use of external cavity designs to narrow the laser linewidth can assist in this reward. Furthermore, the center wavelength of emission must match that of the resonant cavity 125 for SHG. Fluctuations in the environment (e.g., temperature, strain, etc.) can cause the resonant frequency of either the pump laser diode 110 or the wavelength converter 120 to vary. For example, in some instances, both the nonlinear optical element 120 used for wavelength conversion and the laser diode or other light emitting element 110 may use a respective optical resonant cavity 105 and 125. If each of these resonant cavities 105, 125 operates independently without a mechanism for ensuring that their respective resonant frequencies are matched, an external control circuit or system may be required to maintain a frequency lock between the two resonant cavities 105, 125 by incorporating wavelength tuning elements into the design.

Some embodiments of the present disclosure may be directed to addressing challenges relating to resonant frequency matching between the (active) light emitting element 110 and the (passive) nonlinear optical element(s) 120 used for wavelength conversion. In particular, some embodiments may eliminate the use of two distinct cavities, by instead merging the optical resonant cavity 105 of the pump laser with the resonant cavity 125 of the wavelength converter. Collectively, such embodiments may be referred to herein as intracavity optical frequency conversion because the SHG material of the nonlinear optical element 120 is provided inside of (or otherwise coupled between respective ends of) the lasing cavity 105, which defines lasing at the fundamental wavelength (or pump frequency) of the pump laser diode, also referred to herein as the lasing cavity 105.

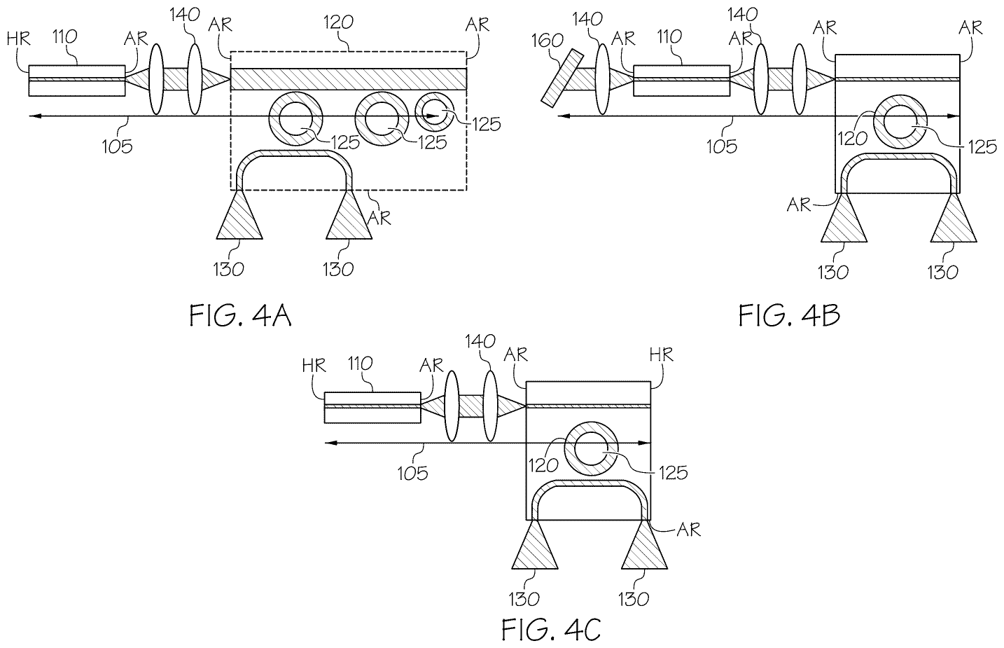

FIGS. 4A, 4B, and 4C illustrate example designs based on hybrid integration of an external cavity laser diode 110 pumping intracavity resonant SHG waveguides 120 (implemented as a ring resonator including resonant cavity 125), with a third component medium (including lenses 140 and/or diffraction gratings 160) for chip-to-chip transfer of light. The SHG waveguides 120 are at least partially within the lasing cavity 105 (e.g., between first and second ends of the lasing cavity 105, denoted by double-sided arrows herein). The integration includes multiple semiconductor chips and materials (e.g., the laser 110 and the NLO 120 may each be implemented by a respective chip and formed of a different semiconductor material), and is thus hybrid. Two output coupling elements 130 are provided. A single frequency may be generated from a Vernier Effect between the laser FP (Fabry-Perot) resonant frequencies and ring resonant frequencies.

Several advantages may be realized by implementing the nonlinear optical element 120 as a resonant SHG waveguide in the lasing cavity 105. For example, the SHG material can access higher field intensities at the pump frequency than after the pump beam has exited the lasing cavity 105 (simplistically, the intracavity intensity of a laser may be related to its emitted beam by 1/(1−Reflectivity_outputcoupler)). Also, there may no longer be two separate and distinct center frequencies corresponding to either the light emitting element 110 or the nonlinear optical element 120. Instead, the respective resonant cavities 105 and 125 are optically coupled to one another. As such, any variations in one resonant cavity 125 will affect the other cavity 105, by way of the photons that are contained within the respective resonant cavities 105, 125. For example, if there is a variation in the center frequency of a ring resonator 120 made of nonlinear optical material that is coupled to the lasing cavity 105 of a blue laser 110, the variation (or “drift”) in the center frequency will be registered through an increase in population of photons at the new (varied) frequency. These will feed back into the lasing cavity 105 and shift the center frequency of lasing into agreement with the new frequency of the nonlinear optical material cavity. The potential for this automatic, speed-of-light optical feedback may be a significant benefit of integrating the SHG material or element 120 within the lasing cavity 105 (intracavity) of the laser diode 110.

Some embodiments of the present disclosure may arise from recognition that, to implement configurations that introduce passive and/or nonlinear optical materials or elements 120 into the active lasing cavity 105, it may be necessary to achieve relatively low optical losses in coupling the passive and/or nonlinear optical material (e.g., AlN) to the lasing cavity 105. To meet this constraint, embodiments of the present disclosure utilize heterogeneous integration of different materials to realize intracavity designs. Some embodiments of the present disclosure thus provide integrated photonic circuit designs and structures that integrate nonlinear optical elements 120 of one semiconductor material into the optical cavity of the light emitting element 110 of a different semiconductor material for UV generation. In particular, embodiments of the present disclosure provide solid-state far-UVC light sources including structures with heterogeneous integration of intracavity nonlinear optical elements 120, that is, nonlinear optical elements 120 that are provided within the lasing cavity 105 of a laser 110.

Components used in embodiments of the present disclosure may include light emitting elements 110 (e.g., laser diodes, such as based on Group II-V or III-V semiconductor materials), nonlinear optical elements 120, lenses 140, mirrors 170, optical diffraction gratings 160, and waveguides 115. Waveguides 115 as described herein may include nonlinear optical materials (e.g., AlN-, AlScN-, AlGaN-based materials) and/or other materials (e.g., SiN or SiO or SiON-based materials; also referred to as SiOxNy). That is, in some embodiments, the functionality of the waveguides 115 and the nonlinear optical elements 120 may be combined (e.g., as a SHG waveguide). Components or elements that are “coupled” may refer to physical coupling (with physical contact between component or elements) and/or optical coupling (with light output from one component or element directed into another component or element). Methods of optical feedback may include facet coatings, double ring configurations, diffraction gratings, or loopback mirrors, (e.g., to reflect only ˜440 nm light, rather than the ˜220 nm light).

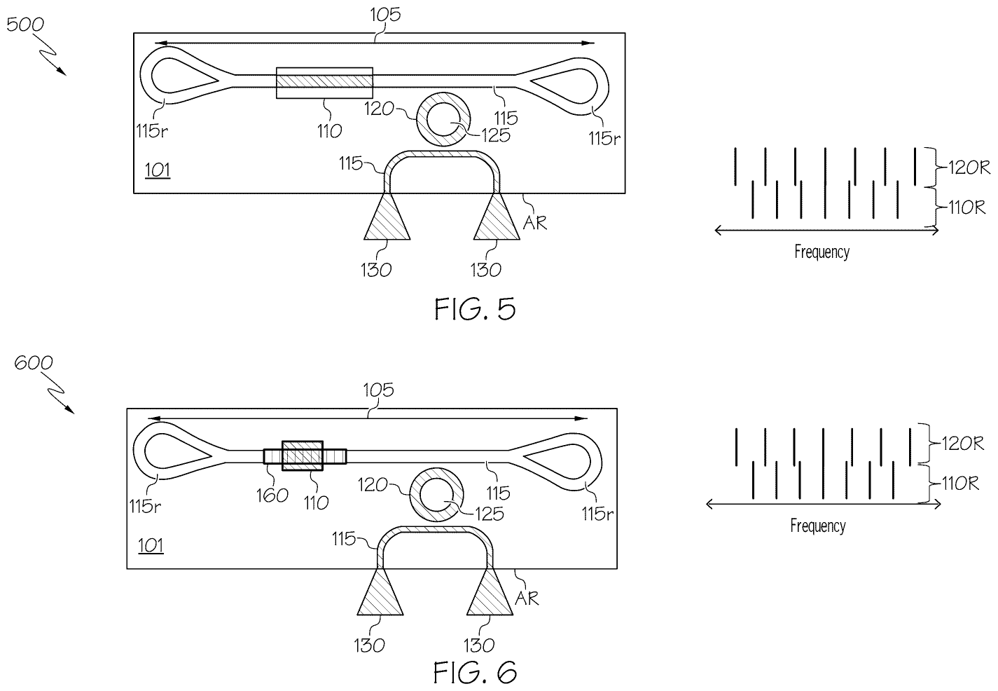

FIG. 5 illustrates an example of a light source or PIC chip 500 including heterogeneous integration of an active light emitting element 110 with a passive intracavity nonlinear optical element (NLO) 120 according to some embodiments of the present disclosure. The embodiment shown in FIG. 5 provides heterogeneous integration of an active light emitting element 110 (shown as a laser or gain chip), waveguides 115 (which may be an AlN-based or SiN-based waveguide, such as AlN/AlScN/AlGaN or SiOₓN_{y}) including a loopback mirror 115r), and a NLO element 120 (shown as a ring-shaped resonant SHG waveguide) on a common substrate 101. It will be understood that “ring-shaped” may be used herein to describe any closed-loop element, including elliptical, oblong, and “racetrack” shapes, and thus, does not require the element to be perfectly circular. The NLO element 120 is optically coupled to the light emitting element 110 between opposing ends of the lasing cavity 105 to receive the light of the first wavelength (e.g., blue light) emitted by the laser 110, generate light of a second wavelength (e.g., far UVC light), and output the light of the second wavelength via waveguide 115 and output coupling elements 130. In greater detail, the light emitted by the laser 110 is coupled into and out of the resonant cavity 125 of the NLO element 120, with unconverted light from the laser 110 being coupled back into the lasing cavity 105 (rather than being lost) and directed back into the resonant cavity 125.

As shown in FIG. 5, the light that is output from the NLO element 120 may include synchronous resonances (and thus, frequency doubling) generated from a Vernier Effect between the laser FP resonant frequencies and NLO resonant frequencies. As noted above, the output waveguide 115 and/or output coupling element(s) 130 may be configured to provide selective light extraction, such that a desired frequency or wavelength of the light output from the NLO element 120 (e.g., 220 nm) is preferentially outcoupled, while other frequencies (e.g., 440 nm) are attenuated or blocked. The substrate 101 may be (but is not necessarily) native to either the light emitting element 110 or the NLO element 120 (or the waveguide 115, e.g., for an AlN-based waveguide that is epitaxially formed on the substrate 101) in some embodiments.

FIG. 6 illustrates another example of a light source or PIC chip 600 including heterogeneous integration of an active light emitting element 110 (shown as a laser or gain chip) with a passive intracavity nonlinear optical element 120 (shown as a ring-shaped resonant SHG waveguide) on a substrate 101 according to some embodiments of the present disclosure. The light source 600 of FIG. 6 may be implemented in a similar configuration as the light source 500 of FIG. 5, except that the laser 110 is implemented as a surface emitting laser (e.g., a vertical cavity surface emitting laser (VCSEL) or PCSEL) that is coupled to the waveguide 115 (e.g., AlN/AlScN/AlGaN or SiOxNy) by a diffraction grating 160 (which converts the vertically propagating/out of plane light emitted from the laser 110 into horizontally propagating/in-plane light). That is, the diffraction grating 160 is configured to direct the light output from the surface emitting laser 110 (which may be propagating in a direction perpendicular to the substrate 101) into a direction of extension or plane of the waveguide 115 (parallel to the substrate 101). The light of the first frequency as output from the laser 110 is otherwise similarly directed into the resonant cavity 125 of the NLO element 120 for generation of light of the second wavelength, which is (selectively) output via waveguide 115 and output coupling elements 130 as described with reference to FIG. 5.

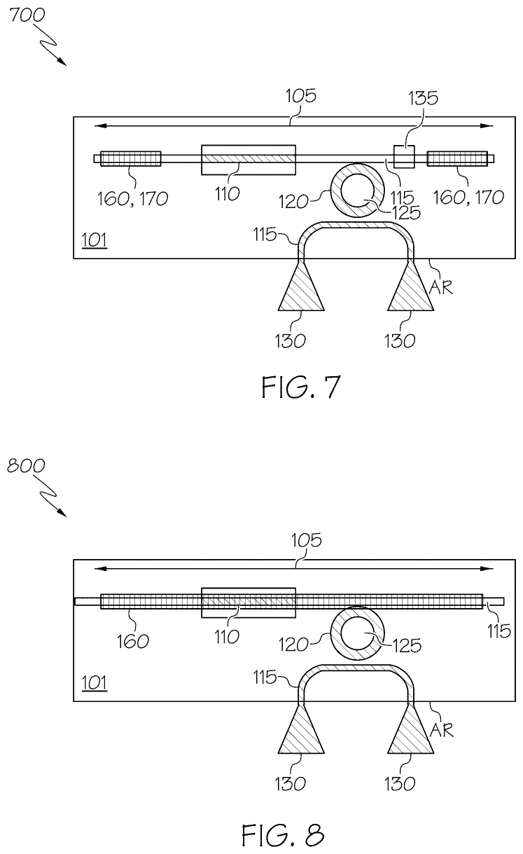

FIG. 7 illustrates another example of a light source or PIC chip 700 including heterogeneous integration of an active light emitting element 110 (shown as a laser or gain chip) with a passive intracavity nonlinear optical element 120 (shown as a ring-shaped resonant SHG waveguide) on a substrate 101, and further including diffraction gratings 160 and a phase tuning mechanism 135 according to some embodiments of the present disclosure. The light source 700 of FIG. 7 may be implemented in a similar configuration as the light source 500 of FIG. 5, except that diffraction gratings 160 (or alternatively, reflector mirrors 170) are provided on opposing ends of the waveguide 115 to reflect light back into the lasing cavity 105. The phase tuning mechanism 135 may be implemented electronically (e.g., using electromagnetic fields and electro-optic effects) and/or thermally (e.g., using a heating element) to alter the index of refraction of the waveguide 115. The light of the first frequency as output from the laser 110 is otherwise similarly directed into the resonant cavity 125 of the NLO element 120 for generation of light of the second wavelength, which is (selectively) output via waveguide 115 and output coupling elements 130 as described with reference to FIG. 5.

FIG. 8 illustrates another example of a light source or PIC chip 800 including heterogeneous integration of an active light emitting element 110 (shown as a laser or gain chip) with a passive intracavity nonlinear optical element 120 (shown as a ring-shaped resonant SHG waveguide) on a substrate 101, according to some embodiments of the present disclosure. The light source 800 of FIG. 8 may be implemented in a similar configuration as the light source 500 of FIG. 5, except that the optical cavity 105 of the laser 110 is implemented by or includes a diffraction grating 160, which may be a single grating extending along a length of the waveguide 115 (e.g., a Distributed Feedback (DFB) laser). For example, the grating 160 may be implemented by patterning the waveguide 115. The light of the first frequency as output from the laser 110 is otherwise similarly directed into the resonant cavity 125 of the NLO element 120 for generation of light of the second wavelength, which is output (selectively, in some embodiments) via waveguide 115 and output coupling elements 130 as described with reference to FIG. 5.

Embodiments of the present disclosure thus provide structures including heterogeneous integration of disparate materials (in some examples, III-V materials and AlN materials) to provide intracavity nonlinear optical processes. As described in greater detail below, such structures may be integrated on a common substrate, i.e., heterogeneously integrated, where the substrate may be native to one of the disparate materials in some embodiments.

Further embodiments of the present disclosure provide methods of fabricating solid-state far-UVC light sources including heterogeneous integration (also referred to as HI) of light emitting elements 110 and intracavity optical elements (including but not limited to nonlinear optical elements 120) of different materials to achieve low loss coupling. Such optical losses may typically be attributed to (1) transitioning from a high refractive index medium to a low refractive index medium (e.g., air) and back again, and (2) alignment of the light such that the field intensity of source and target modes are matched. In other words, misalignment of any sort can introduce loss as well as any changes in the dimension of the guided modes in the source and target devices. Embodiments described herein bring together semiconductor materials for active light emitting elements 110 (e.g., III-V semiconductor materials) with semiconductor materials for passive optical elements 120 (e.g., AlN, AlScN, AlGaN), resulting in a single, solid state chip (that is, without semiconductor-air interfaces or “air gaps” between semiconductor elements).

The integration processes described herein can add active device materials to passive nonlinear optical materials (or native substrate thereof as the host or target substrate), or conversely, can add passive nonlinear optical materials to the active device materials. For example, an AlN-based nonlinear optical element 120 (or native growth substrate thereof) may be the host/target substrate, or may be the chip/wafer that is placed on a non-native substrate. Further embodiments may transfer both the active device materials and the passive nonlinear optical materials onto a common third substrate or material platform, for example, using transfer printing. The active and passive elements may be edge coupled in-plane (i.e., where planes of the active and passive elements do not overlap and are coplanar, and the coupled passive elements are substantially aligned to the active elements in the direction of light propagation) or evanescently coupled in-plane or out-of-plane (i.e., where the planes of the coupled elements overlap one another and are offset from the direction of light propagation as output from the active elements, for example, with vertical waveguide coupling elements therebetween), such that the evanescent field generated by one element excites the other.

The solid-state far-UVC light sources that may be formed using HI processes described herein may be similar to those described in the above-referenced PCT Application No. PCT/US2023/013187, which describes systems that combine active laser diodes with nonlinear components for frequency conversion (e.g., SHG) without air interfaces therebetween. Embodiments as further described herein provide fabrication methods using heterogeneous integration processes that can be used to fabricate such structures and/or additional structures, for example, on a substrate that is native to one of the heterogeneous materials. Particular embodiments are directed to methods by which nonlinear (e.g., AlN-based) passive PIC devices can be brought into photonic contact (i.e., optically coupled) with active (e.g., III-V-based) light sources (such as blue lasers), resulting in a chip or structure that generates light of the desired wavelengths (e.g., far-UVC light). Optical coupling, as used herein, may include coupling by physical contact or connection (e.g., edge coupling) and/or non-physical contact or connection (e.g., evanescent coupling) for propagation of light between elements. The optical coupling may be in-plane or out-of-plane. Elements described herein as “in-plane” may be arranged on or along the optical axis of the light propagation or a plane thereof; in contrast, “out-of-plane” elements may be arranged at angles to the plane of the optical axis of the light.

Some embodiments include methods for bonding light emitting element 110 materials (e.g., III-V materials) into a recess 101r (e.g., an etched pocket) in a substrate surface 101s, for integration with a nonlinear optical element 120 (e.g., AlN) that is formed on the native substrate 101 (e.g., sapphire, AlN, or engineered AlN templates). The use of recessed pockets 101r allows for in-plane coupling of the light emitted by one material (the active light emitting chip 110) into optical elements fabricated from another, different material (the passive nonlinear optical elements 120). As the light output from the active elements are coupled to the passive elements using (approximately) in-plane waveguides 115, these embodiments may be collectively referred to herein as “in-plane” or using “edge-coupling” between the active and passive materials.

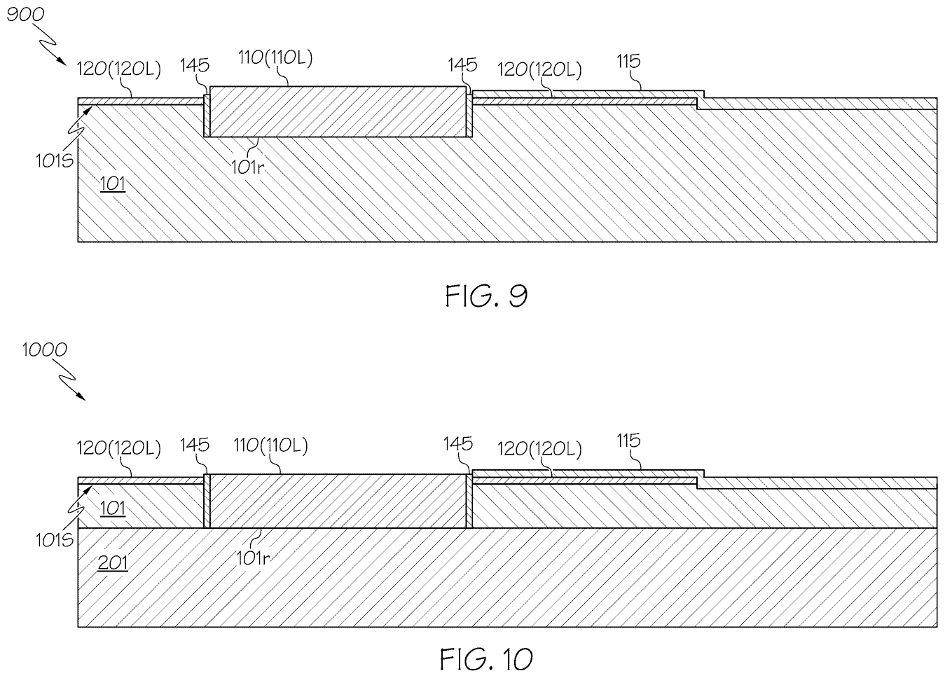

FIG. 9 illustrates methods of bonding a light emitting element 110 (shown as Group III nitride laser) in a recess 101r in a native substrate 101 on which a nonlinear optical material 120L or element 120 (shown as an AlN waveguide) is formed (e.g., by epitaxial growth). The native substrates 101 described herein may be any material that may be suitable for forming the nonlinear optical material layer 120L or element 120 thereon, for example, substrates having a similar lattice constant and/or a different (e.g., lower) refractive index in comparison to the nonlinear optical material. Embodiments are described herein primarily with growth of AlN (as the nonlinear optical material 120L or element 120) on sapphire substrates (as the native growth substrate 101), but the present disclosure is not limited to the specific nonlinear materials and/or native substrate materials described in these examples.

As shown in FIG. 9, a method of forming a light source or PIC chip 900 may include forming (e.g., epitaxially growing) a nonlinear optical material layer 120L (e.g., AlN) on a native substrate 101 (e.g., a sapphire substrate); patterning the nonlinear optical material layer 120L and a portion of the native substrate 101 therebelow to form a recess 101r or pit that extends into a surface 101s of the substrate 101; bonding a light emitting material 110L (e.g., a Group III-V material) within the recess 101r or pit; (optionally) filling portions of the recess 101r or pit with a fill material 145 that is transparent to the light of a first wavelength that is output from the light emitting material 110L; patterning the light emitting element material 110L and the nonlinear optical material 120L to define the light emitting element 110 and the nonlinear optical element 120; and forming additional waveguide element layers 115 (e.g., SiN or SiO or SiON layers) to optically couple the light emitting element 110 to the nonlinear optical element 120.

In greater detail, in the in-plane integration process of FIG. 9, the receiving material system is a thin film of AlN 120L grown on a sapphire substrate 101. That is, the receiving material system 120L/101 may be native for the passive PIC devices 120. After lithographic patterning, a recess 101r or pocket is etched through the AlN 120L and into the sapphire substrate 101. The III-V material stack 110L for the active device is placed and bonded into the recess 101r or pocket, for example, using flip chip bonding, die bonding, micro-transfer printing, or other suitable techniques. After the III-V active device material stack 110L is in place in the recess 101r or pocket, subsequent lithographic steps may be performed to define lateral dimensions of the III-V active device 110 and/or to pattern the AlN 120L to form the PIC of the AlN passive device 120. In some embodiments, waveguides 115 for optically coupling the III-V active device 110 and the AlN passive element 120 may be formed in the same mask step, which may allow for improved or ideal alignment between the active device 110 and passive device(s) 120.

Advantages of bonding a light emitting element 110 in a recess 101r in the native growth substrate 101 of the nonlinear optical element 120 include relatively simple integration with the substrate processing, and use of existing filling and bridging processing techniques. On the other hand, such bonding methods may present challenges with respect to sapphire wafer processing (including potential thermal and optical impacts on processing and handling, respectively), arranging nonlinear optical elements 120 directly above or below the light emitting element 110, and/or providing heat sinking for the light emitting element 110 through the sapphire substrate 101 (which may require thinning of the substrate).

FIG. 10 illustrates additional methods of bonding a light emitting element 110 in a recess 101r in a substrate 101 on which a nonlinear optical material 120L or element 120 is formed.

As shown in FIG. 10, a method of forming a light source or PIC chip 1000 may include forming (e.g., epitaxially growing) a nonlinear optical material layer 120L (e.g., AlN) on a native substrate 101 (e.g., a sapphire substrate); thinning the native substrate 101; bonding a non-native substrate 201 (e.g., a silicon carrier or handling substrate) to the thinned substrate 101; patterning the nonlinear optical material layer 120L and the native substrate 101 to form a recess 101r or pit that extends through the native substrate 101 and to the surface of the handling substrate 201 (or beyond/into the surface of the non-native substrate 201); bonding a light emitting element material 110L (e.g., a Group III-V material) within the recess 101r or pit (e.g., bonding the III-V material directly to the surface of the handling substrate 201 exposed by the recess 101r or pit); (optionally) filling portions of the recess 101r or pit with a fill material 145; patterning the light emitting element material 110L and the nonlinear optical element material 120L to define the light emitting element 110 and the nonlinear optical element 120; and forming additional waveguide element layers 115 (e.g., SiN or SiO or SiON layers) to optically couple the light emitting element 110 to the nonlinear optical element 120.

In greater detail, in the in-plane integration process illustrated in FIG. 10, the native sapphire substrate 101 for the AlN material 120L is bonded to a silicon carrier wafer 201. The silicon carrier wafer 201 serves both as an etch stop as well as a high quality, flat surface with low roughness to which the III-V material 110L can be bonded (e.g., as mentioned above, using flip chip bonding, micro-transfer printing, or other suitable techniques to provide the III-V material 110L into the recess 101r). The silicon carrier wafer 201 may provide better thermal dissipation than the sapphire substrate 101 alone. After the III-V active device material stack 110L is in place in the recess 101r or pocket, subsequent lithographic steps may be performed (e.g., in the same mask step) to define lateral dimensions of the III-V active device 110 and/or the PIC of the AlN passive device 120. Etching, lift off, and optional deposition of upper cladding (as desired) may be performed to complete a PIC chip 1000 including components that lie in a single plane, spanning both the III-V material of the active device and the AlN material of the passive optical element(s).

Advantages of bonding a light emitting element 110 in a recess 101r in a surface 101s of the native growth substrate 101 that exposes the underlying carrier/non-native substrate 201 may include ease of attachment of the light emitting element 110 to the non-native substrate 201 (e.g., attaching the III-V material 110L directly to a silicon handling wafer 201, which may have a relatively smooth substrate surface), use of existing filling and bridging processing techniques, access to larger diameter wafers 201 (e.g., 12″ silicon wafers), and ease of providing heat sinking for the light emitting element 110 to the silicon handling substrate 201. On the other hand, such bonding methods may present challenges with respect to silicon-on-sapphire (SoS) wafer processing, thinning of the sapphire substrate 101 to a minimum thickness needed for handling and bonding (unless AlN growth can be performed on the bonded SoS substrate, despite growth temperatures of about 900 C), and/or arranging nonlinear optical elements 120 directly above or below the light emitting element 110.

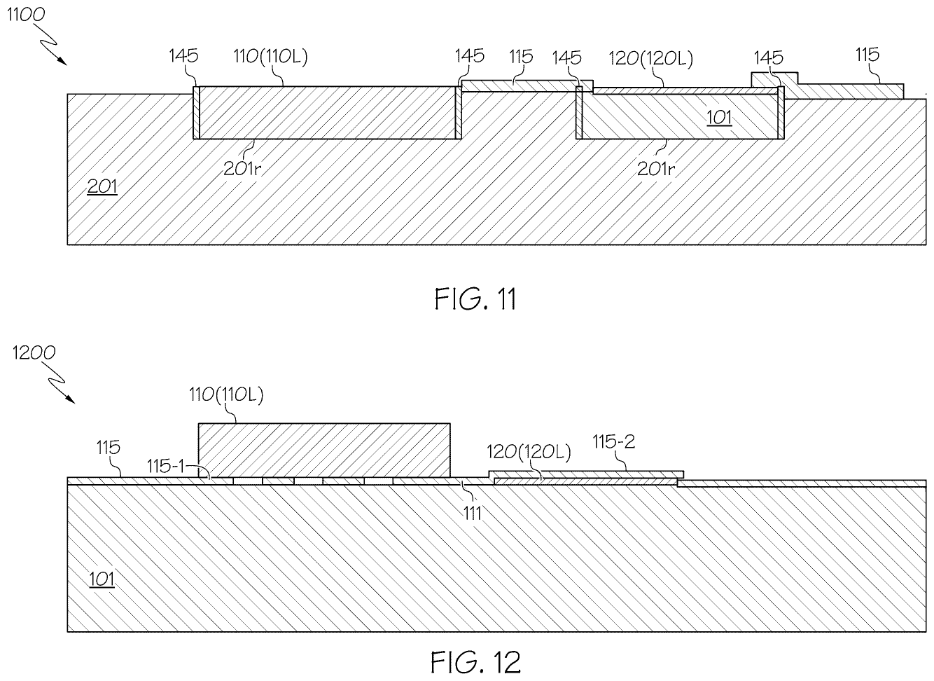

FIG. 11 illustrates additional methods of bonding a light emitting element 110 and an nonlinear optical element 120 into respective recesses 201r in a non-native substrate 201. As shown in FIG. 11, a method of forming a light source or PIC chip 1100 may include forming (e.g., epitaxially growing) a nonlinear optical material layer 120L (e.g., AlN) on a native substrate 101 (e.g., a sapphire substrate); patterning a non-native substrate 201 (e.g., a silicon handling substrate) to define recesses 201r or pits therein; bonding an active light emitting element material 110L (e.g., a Group III-V material) and the nonlinear optical material layer 120L (including a portion of the underlying native substrate 101) within the recesses 201r or pits (e.g., bonding the III-V material 110L and the native sapphire substrate 101 directly to the Si handling substrate 201 at bottom surfaces of the recesses 201r or pits); (optionally) filling portions of the recesses 201r or pits with a fill material 145; patterning the light emitting element material 110L and the nonlinear optical element material 120L to define the light emitting element 110 and the nonlinear optical element 120; and forming additional waveguide element layers 115 (e.g., SiN or SiO or SiON layers) to optically couple the light emitting element 110 to the nonlinear optical element 120.

In greater detail, in the in-plane integration process illustrated in FIG. 11, the silicon carrier or handling wafer 201 is used, but with both the III-V material stack 110L and the AlN-on-sapphire material stack 120L/101 placed into respective recesses 201r or pockets that are etched or otherwise formed in the silicon carrier wafer 201. Other materials (e.g., SiN, SiO, SiON, AlN, etc.) are used to form the waveguides 115 that are fabricated on the silicon carrier wafer 201. For example, SiN may be used as the waveguide 115 due to its optical transparency down to or at near-UV wavelengths.

Advantages of bonding the light emitting element 110 and the native growth substrate 101 for the nonlinear optical element 120 directly to the underlying carrier/non-native substrate 201 may include ease of attachment to the non-native substrate 201, use of existing filling and bridging processing techniques, ease of providing heat sinking for the light emitting element 110 to the silicon handling substrate 201, and use of large area non-native substrate 201 (e.g., 12-inch diameter silicon wafers). On the other hand, such bonding methods may present challenges with respect to singulation of the native growth substrate 101 (e.g., a sapphire chiplet), bonding of multiple chiplets 101, thinning of the native growth substrate 101 prior to integration onto the non-native substrate 201, and arranging nonlinear optical elements 120 directly above or below the light emitting element 110.

Still further embodiments of the present disclosure provide methods for bonding light emitting device materials 110L (e.g., III-V materials) onto a surface of a native substrate 101 for integration with a nonlinear optical element 120 (e.g., AlN) that is formed on the native substrate 101 (e.g., sapphire or engineered AlN). In these embodiments, the plane in which the light propagates in one material is different from that in which it propagates through the other. The transfer of optical energy from one plane to another may be achieved by vertical waveguide couplers, which operate by transferring energy through an evanescent (tail) of the mode, also referred to herein as evanescent coupling.

FIG. 12 illustrates methods of bonding a light emitting element 110 to a waveguide material 115 on a surface of a native substrate 101 on which a nonlinear optical material 120L is formed (e.g., by epitaxial growth). As shown in FIG. 12, a method of forming a light source or PIC chip 1200 may include forming (e.g., epitaxially growing) a nonlinear optical material layer 120L (e.g., AlN) on a native substrate 101 (e.g., a sapphire substrate); depositing and patterning additional waveguide element layers 115 (e.g., SiN or SiO or SiON layers) on surface of the native substrate 101, including portions 115-2 of the waveguide element layers 115 on the nonlinear optical element material 120L, for optical coupling; bonding a light emitting element material 110L (e.g., a Group III-V material) on the waveguide element layers 115 (e.g., bonding the III-V material 110L directly to the patterned SiN/SiO/SiON waveguide layers 115 such that portions 115-1 of the waveguide layers 115 are between the light emitting element material 110L and the substrate 101); and patterning the light emitting element material 110L and the nonlinear optical element material 120L to define the light emitting element 110 and the nonlinear optical element 120. Vertical waveguide couplers (e.g., using tapers) and/or evanescent coupling may be used to move light 111 from one plane (i.e., the plane of propagation of the light 111 as output from the light emitting element 110) to another (i.e., the plane of the waveguide 115 and the nonlinear optical element 120).

Advantages of bonding a light emitting element 110 to the waveguide material layer 115 on a surface of the native growth substrate 101 of the nonlinear optical element 120 include the use of some conventional methods for attaching III-V materials 110L directly to patterned SiN/SiO/SiON waveguide features 115, and for directly integrating SiN/SiO/SiON waveguide features 115 with the III-V device 110. On the other hand, such bonding methods may present challenges with respect to complications from topology of the patterned AlN element 120, sapphire wafer processing (including potential thermal and optical impacts on processing and handling, respectively), and/or providing heat sinking for the light emitting element 110 through the sapphire substrate 101 (which may require thinning of the substrate 101).

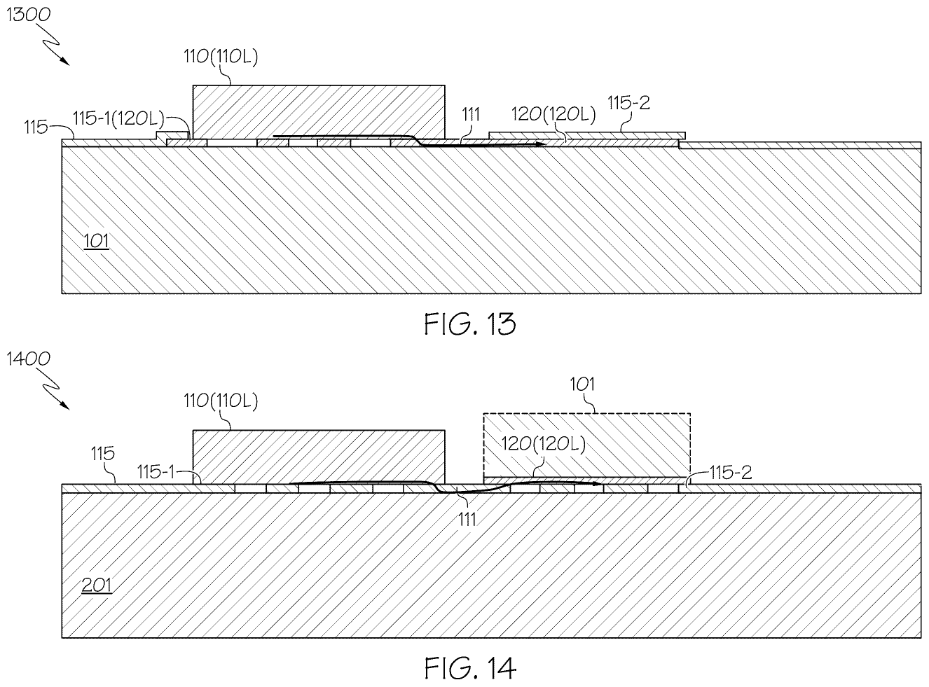

FIG. 13 illustrates methods of bonding a light emitting element 110 directly onto a nonlinear optical material 120L on a surface of the native substrate 101. As shown in FIG. 13, a method of forming a light source or PIC chip 1300 may include forming (e.g., epitaxially growing) a nonlinear optical material layer 120L (e.g., AlN) on a native substrate 101 (e.g., a sapphire substrate); depositing and patterning additional waveguide material layers 115 (e.g., SiN or SiO or SiON layers) on the surface of the native substrate 101, including portions 115-2 of the waveguide element layers 115 on the nonlinear optical element material 120L, for optical coupling; bonding a light emitting element material 110L (e.g., a Group III-V material) on portions 115-1 of the nonlinear optical material layer 120L (e.g., bonding the III-V material 110L directly to portions 115-1 of the patterned AlN layer 120L) to provide a waveguide portion 115-1 formed of the nonlinear optical element material 120L (which may thus be native to the substrate 101) between the light emitting element material 110L and the substrate 101; and patterning the light emitting element material 110L and the nonlinear optical element material 120L (in particular, portions of the nonlinear optical element material 120L that are non-overlapping with the light emitting element material 110L) to define the light emitting element 110 and the nonlinear optical element 120. Evanescent coupling may be used to move light 111 from one plane (i.e., the plane of propagation of the light 111 as output from the light emitting element 110) to another (i.e., the plane of the nonlinear optical element material 120L, including waveguide portions 115-1), as indicated by the arrow which originates in the plane of the III-V device 110 and is shifted down to the plane containing the SiN (or SiO or SiON or AlN) waveguides 115.

In greater detail, the integration process shown in FIG. 13 may be implemented by adding a III-V material stack 110L on top of a thin film of AlN 120L, which was previously grown on a sapphire substrate 101. After bonding of the III-V material stack 110L to the patterned AlN features 120L (and removal of any excess material from the top of the III-V material 110L), the III-V material 110L may be patterned by subsequent lithographic process steps to provide improved or ideal alignment between the III-V material stack 110L and the waveguides 115-1 formed from the AlN film 120L. As mentioned, the transfer of light to the waveguides 115-1 in the AlN material 120L may be achieved by evanescent coupling from the III-V material 110L to the AlN layers 115-1, 120L.

Some aspects of the approach shown in FIG. 13 may include (i) bonding of the light emitting element material 110L (e.g., the III-V material) to area(s) of unpatterned or patterned nonlinear optical material 120L (e.g., AlN), supporting optical coupling between the two stacked materials 110L and 120L; (ii) retaining the nonlinear optical element features 120 (e.g., AlN) on the native growth substrate 101 (sapphire, or engineered AlN substrate, or similar); and using the nonlinear optical material 120L (e.g., AlN) as the primary waveguiding material for the waveguide portions 115-1 that extend between the light emitting element 110 and the substrate 101. That is, the material of one or more waveguide portions 115-1 may be native to the substrate 101 in some embodiments.

Advantages of bonding a light emitting element 110 to the nonlinear optical element material layer 120L on a surface of the native growth substrate 101 may include the use of some conventional methods for attaching III-V materials 110L, and increased flexibility for AlN waveguide portions 115-1 interfacing with the III-V device 110. On the other hand, such bonding methods may present challenges with respect to complications from sapphire wafer processing (including potential thermal and optical impacts on processing and handling, respectively), potential impact on AlN film 120L properties from the bonding process, and/or providing heat sinking for the light emitting element 110 through the sapphire substrate 101 (which may require thinning of the substrate).

FIG. 14 illustrates methods of bonding a light emitting element 110 and a nonlinear optical element 120 to a waveguide 115 on a surface of a suitable non-native substrate 201 (e.g., a substrate 201 that is transparent to the wavelengths of light described herein and having a different or lower refractive index material than the waveguide elements 115, including sapphire, silicon (with a relatively thick oxide layer thereon, as shown in FIGS. 20-22), or other substrates). As shown in FIG. 14, a method of forming a light source or PIC chip 1400 may include forming (e.g., epitaxially growing) a nonlinear optical material layer 120L (e.g., AlN) on a native substrate 101 (e.g., a sapphire substrate); depositing and patterning waveguide element layers 115 (e.g., SiN or SiO or SiON layers) on a surface of a different substrate 201 (also referred to as a device substrate) for optical coupling; bonding a light emitting element material 110L (e.g., a Group III-V material) on the waveguide element layers 115 (e.g., bonding the III-V material 110L directly to the patterned SiN/SiO/SiON waveguide elements 115); bonding the native substrate 101 having the nonlinear optical element material layer 120L thereon onto the waveguide element layers 115 (e.g., flipping the sapphire substrate 101 and bonding the AlN material 120L (face-down) directly onto the patterned SiN/SiO/SiON waveguide elements 115); removing the native growth substrate 101 (as shown by dashed lines); and patterning the light emitting element material 110L and the nonlinear optical element material 120L to define the light emitting element 110 and the nonlinear optical element 120. Vertical waveguide couplers (e.g., using tapers) and/or evanescent coupling may be used to move light 111 from one plane (i.e., the plane of propagation of the light 111 as output from the light emitting element 110) to another (i.e., the plane of the waveguide 115 and the plane of the nonlinear optical element 120 stacked thereon).

In greater detail, the integration process shown in FIG. 14 may be implemented by bonding the III-V material layer stack 110L to a passive waveguide 115. A thin intermediate layer (not shown) may be provided between the III-V material layer stack 110L and the passive waveguide 115 in some embodiments. The passive waveguide 115 in the embodiment of FIG. 14 is formed of an intermediate material (e.g., SiN, SiO, or SION) that is transparent to the wavelengths of light output from the light emitting element 110 (e.g., visible light, such as blue light) and/or the light generated by the nonlinear optical element 120, but is a different material from AlN (or other nonlinear material 120L for UV generation). Instead, the AlN layer 120L is provided using a separate, flip chip bonding process, which brings the AlN epitaxial layer 120L into contact with the intermediate material (SiN/SiO/SiON) of the waveguide elements 115. After bonding the III-V material layer stack 110L and flipping the sapphire substrate 101 and bonding the AlN material 120L directly to the patterned SiN/SiO/SiON waveguide elements 115, the sapphire substrate 101 is removed, exposing the AlN layer 120L, which is patterned along with the III-V material stack 110L and the intermediate SiN/SiO/SiON material 115 in the same lithographic step, providing improved or ideal alignment between the waveguides 115 at interfaces between elements of different materials (in particular, at interfaces between portions 115-1 of the waveguide 115 and the light emitting element, and at interfaces between portions 115-2 of the waveguide 115 and the nonlinear optical element 120).

Some aspects of the embodiment shown in FIG. 14 may include (i) bonding of the light emitting element material 110L (e.g., the III-V material) to area(s) of unpatterned or patterned waveguide element layers 115 (e.g., SiN or SiO or SiON layers) for optical coupling; (ii) bonding the nonlinear optical element material 120L (e.g., AlN) to area(s) of unpatterned or patterned waveguide element layers 115 (e.g., SiN or SiO or SiON layers) to integrate the nonlinear optical element 120 on the device substrate 201 (e.g., sapphire, silicon, or other substrate); (iii) removing the native growth substrate 101 (e.g., sapphire, or engineered AlN substrate, or similar) of the nonlinear optical element material 120L, leaving the nonlinear optical element material 120L (e.g., AlN) on the device substrate 201; (iv) providing optical coupling between the nonlinear optical element 120 (e.g., AlN) and the waveguide elements 115 (e.g., SiN or SiO or SiON), and (v) using multiple materials (e.g., SiN/SiO/SiON materials 115 and AlN or other nonlinear optical material 120L) as waveguiding materials.

Advantages of bonding the light emitting element 110 and the nonlinear optical element 120 to the waveguide material layers 115 on a surface of the device substrate 201 may include providing the optical coupling between the nonlinear optical element 120 (e.g., AlN) and the waveguide elements 115 (e.g., SiO/SiN/SiON) out-of-plane, without waveguide (WG) crossing topology from the nonlinear optical element 120, the use of some conventional methods for attaching III-V materials 110L onto (e.g., directly onto) patterned SiO/SiN/SiON waveguide elements 115, and providing the optical coupling between the SiO/SiN/SiON waveguide elements 115 and the III-V device 110 out-of-plane. On the other hand, such bonding methods may present challenges with respect to complications from wafer processing (including potential thermal and optical impacts on processing and handling, respectively), and/or providing heat sinking for the light emitting element 110 through the (e.g., sapphire) substrate 201, which may require thinning of the substrate 201.

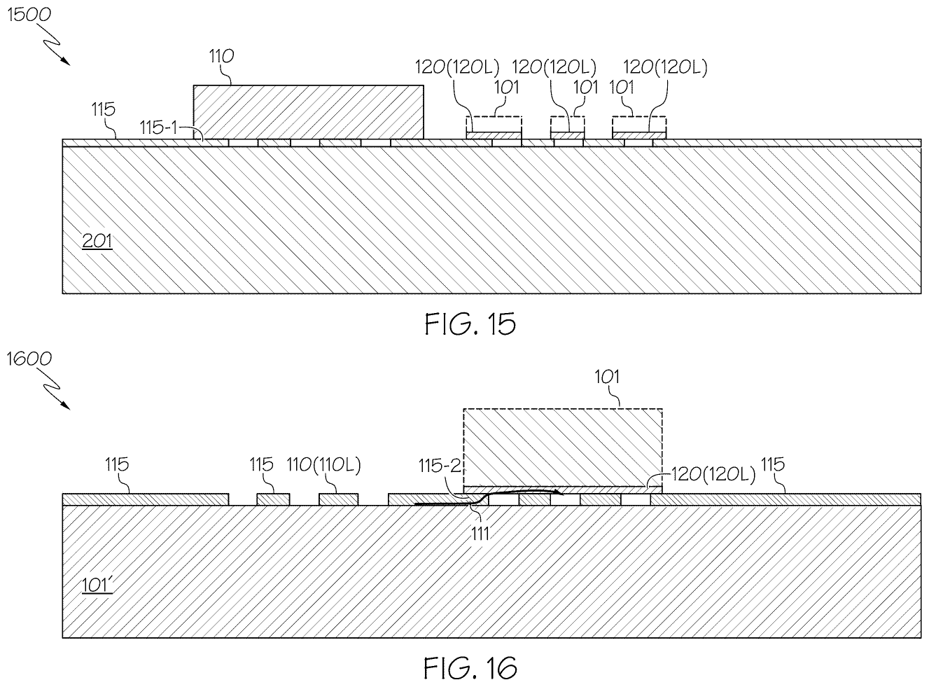

FIG. 15 illustrates methods of bonding a light emitting element 110 and a patterned nonlinear optical element 120 to a waveguide material 115 on a surface of a device substrate 201. As shown in FIG. 15, a method of forming a light source or PIC chip 1500 may include forming (e.g., epitaxially growing) a nonlinear optical material layer 120L (e.g., AlN) on a native substrate 101 (e.g., a sapphire substrate); depositing and patterning waveguide element layers 115 (e.g., SiN or SiO or SiON layers) on a surface of a non-native substrate 201 (also referred to as the device substrate) for optical coupling; bonding a light emitting element material 110L (e.g., a Group III-V material) on the waveguide element layers 115 (e.g., bonding the III-V material 110L directly to the patterned SiN/SiO/SiON waveguide elements 115); bonding the native substrate 101 having the nonlinear optical element material layer 120L thereon onto the waveguide element layers 115 (e.g., flipping the sapphire substrate 101 and bonding the AlN material 120L directly to the patterned SiN/SiO/SiON waveguide elements 115); thinning the native substrate 101; and patterning the light emitting element material 110L and the native substrate 101 (having the nonlinear optical element material 120L thereon) to define the light emitting element 110 and the nonlinear optical element 120. Vertical waveguide couplers (e.g., using tapers) and/or evanescent coupling may be used to move light 111 from one plane (i.e., the plane of propagation of the light 111 as output from the light emitting element 110) to another (i.e., the plane of the waveguide 115 and the plane of the nonlinear optical element 120 stacked thereon).

In greater detail, the integration process shown in FIG. 15 may be implemented by bonding both the III-V material stack 110L and the AlN film 120L to the SiN/SiO/SiON waveguide elements 115 formed of an intermediate material (or other material that is optically transparent at visible wavelengths). In contrast to the embodiment of FIG. 14, the sapphire substrate 101 may not be entirely removed from the AlN thin film 120L. Instead, the sapphire substrate 101 may be thinned such that a thin layer of sapphire 101 remains as an upper cladding layer for the AlN film 120L. This thin sapphire layer 101 is included in the patterning process that defines lateral features or dimensions of the III-V (or other light emitting) material 110L and the AlN (or other nonlinear optical) material 120L.

Some aspects of the embodiment shown in FIG. 15 may include (i) bonding of the light emitting element material 110L (e.g., the III-V material) to area(s) of unpatterned or patterned waveguide element layers 115 (e.g., SiN or SiO or SiON layers) for optical coupling; (ii) bonding the nonlinear optical element material 120L (e.g., AlN) to area(s) of unpatterned or patterned waveguide element layers 115 (e.g., SiN or SiO or SiON layers) to integrate the nonlinear optical element 120 on the device substrate 201 (e.g., sapphire, silicon, or other substrate); (iii) retaining the native growth substrate 101 (sapphire, or engineered AlN substrate, or similar) of the nonlinear optical element 120L to provide physical support/structural stability and optical cladding for the nonlinear optical element material 120L (e.g., AlN); (iv) providing optical coupling between the nonlinear optical element 120 (e.g., AlN) and the waveguide elements 115 (e.g., SiN or SiO or SiON); and (v) using multiple materials (e.g., SiN/SiO/SiON materials 115 and AlN or other nonlinear optical material 120L) as waveguiding materials.

Advantages of bonding the light emitting element 110 and the nonlinear optical element 120 to the waveguide material layers 115 on a surface of the device substrate 201 may include providing the optical coupling between the nonlinear optical element 120 (e.g., AlN) and the waveguide elements 115 (e.g., SiO/SiN/SiON) out-of-plane, without waveguide (WG) crossing topology from the nonlinear optical element 120, the use of the thinned native substrate 101 (e.g. sapphire) to provide support to the relatively thin (˜300 nm) nonlinear optical element(s) 120, the use of some conventional methods for attaching III-V materials 110L directly to patterned SiO/SiN/SiON waveguide elements 115, and providing the optical coupling between the SiO/SiN/SiON waveguide elements 115 and the III-V device 110 out-of-plane. On the other hand, such bonding methods may present challenges with respect to complications from wafer processing (including potential thermal and optical impacts on processing and handling, respectively), and/or providing heat sinking for the light emitting element 110 through the (e.g., sapphire) substrate 201, which may require thinning of the substrate 201.

Yet further embodiments of the present disclosure provide methods for bonding a nonlinear optical element 120 (e.g., AlN) onto a surface of a substrate 101′ for integration with a light emitting element 110 that is formed on the substrate 101′ (e.g., a III-V-based active device or wafer). That is, the substrate 101′ may be non-native to the nonlinear optical element 120, but may be native to the light emitting element 110.

FIG. 16 illustrates methods of bonding a nonlinear optical element 120 to a waveguide element 115 on a surface of light emitting element 110 (or, in particular, a surface of a native substrate 101′ of the light emitting element 110). As shown in FIG. 16, a method of forming a light source or PIC chip 1600 may include forming (e.g., epitaxially growing) a light emitting element material 110L (e.g., a Group III-V material) on a native substrate 101′ of the light emitting element 110 (also referred to as the active device substrate 101′); (optionally) depositing and patterning waveguide element layers 115 (e.g., SiN or SiO or SiON layers) on a surface of the light emitting element material 110L (or the active device substrate 101′) for optical coupling; forming (e.g., epitaxially growing) a nonlinear optical material layer 120L (e.g., AlN) on a native substrate 101 (e.g., a sapphire substrate); bonding the native substrate 101 having the nonlinear optical element material layer 120L thereon onto the active device wafer 101′ (e.g., flipping the sapphire substrate 101 and bonding the AlN material 120L directly to the patterned SiN/SiO/SiON waveguide elements 115 or directly onto III-V active light emitting material layers 110L); at least partially removing the sapphire/native substrate 101, such that the nonlinear optical element material 120L remains on the active device substrate 101′; and patterning the light emitting element material 110L and the nonlinear optical element material 120L to define the light emitting element 110 and the nonlinear optical element 120. Vertical waveguide couplers (e.g., using tapers) and/or evanescent coupling may be used to move light 111 from one plane (i.e., the plane of propagation of the light 111 as output from the light emitting element 110 or the waveguide elements 115) to another (i.e., the plane of the nonlinear optical element 120 stacked thereon).

FIG. 16 is one example of various embodiments in which the passive nonlinear optical element 120 (and, in some instances, the native substrate 101 thereof) is integrated onto the native substrate or wafer 101′ upon which the active light emitting element material layers 110L are formed. In the example of FIG. 16, evanescent coupling is used to direct light 111 from the light emitting device 110 into the nonlinear optical element 120. While not illustrated, air or other material with a lower refractive index than AlN (i.e., about 2.15 at 450 nm) may be used in the bottom cladding of the AlN (or other nonlinear optical material 120L) element.

More generally, the example shown in FIG. 16 illustrates that, rather than integrating the light emitting element 110 with the native substrate 101 of the nonlinear optical element 120, the nonlinear optical element 120 (or material 120L) may be bonded to or otherwise integrated with the native substrate 101′ of the light emitting element 110 in some embodiments.

HI approaches as described herein may also provide advantages with respect to relative size and impact on directionality (i.e., providing a passive PIC 120 onto active light emitting element 110, or providing an active light emitting element 110 onto a passive PIC 120). In particular, while some conventional integration of III-V materials to PICS may target a PIC that has a large area (such as complex silicon-based PICs including multiple components and devices) relative to the size of the III-V active device/light source, embodiments of the present disclosure may typically involve PICs 120 with areas that are smaller (or on the same order of magnitude) as the active device/light emitting element 110. For example, some embodiments may include AlN-based PIC devices 120 as small as 10 μm×10 μm, or perhaps even smaller. That is, embodiments of the present disclosure may provide heterogeneous integration for small areas (die, chiplets) of the nonlinear optical material 120L (i.e. a passive PIC 120) onto the native substrate 101′ of the active device/light emitting element 110. The nonlinear optical material 120L may be integrated in the form of an epilayer (e.g., using micro transfer printing), or may be integrated along with some portion of its native growth substrate 101 remaining as a structural handle (e.g., via die bonding, chiplet bonding, or micro transfer printing).

Some benefits of providing a comparatively small area of nonlinear optical material 120L (e.g., AlN) into a comparatively large area active device wafer 101′ (e.g., a III-V semiconductor wafer) may include, but are not limited to, thermal sinking of the active device 110 (which benefits from remaining on its native substrate 101′), lower processing costs (e.g., for electron beam lithography), and/or lower material costs (e.g., as AlN or other nonlinear optical material 120L may be more expensive than III-V active device materials 110L). For example, while sapphire may be used as a native substrate for AlN, in other embodiments an AlN substrate may be used to grow the AlN epilayers. As AlN substrates are relatively more expensive than sapphire substrates, there may be benefits to spreading the (relatively small area) AlN across a III-V-based wafer 101′, which may be significantly larger in area than the AlN PICs 120.

The nonlinear optical material(s) 120L may be provided on such larger active device substrates 101′ using various techniques (e.g., die bonding, chiplet bonding, or micro transfer printing), such as described herein. For example, an AlN epilayer 120L may be released from an AlN native substrate 101 using a thin film of AlGaN that can serve as a lift off layer (LLO) or etch release layer. As another example, where the AlN-on-sapphire element (120L-on-101) is flipped and mounted (AlN-side down), a thin portion of the AlN epilayer 120L that is closest to the sapphire substrate 101 (i.e., along the AlN-substrate interface 120L-101) may be eliminated, which may be beneficial to the material properties of the remaining AlN epilayer 120L (e.g., lower loss). While micro transfer printing may typically be used for transferring completed devices or elements, embodiments as described herein are not limited to micro transfer printing of completed elements. Rather, some embodiments may integrate the nonlinear optical material 120L of an incomplete device or structure onto the active device substrate 101′ first (e.g., by micro transfer printing), and may subsequently form a waveguide 115 or other structure from the nonlinear optical material 120L, after transfer to the active device substrate 101′. For example, printing blanket epilayers of nonlinear optical material 120L onto the active device substrate 101′ may allow lithography to be used for alignment of PIC waveguides 115 (e.g., formed from the nonlinear optical material 120L) to the active light emitting devices 110.

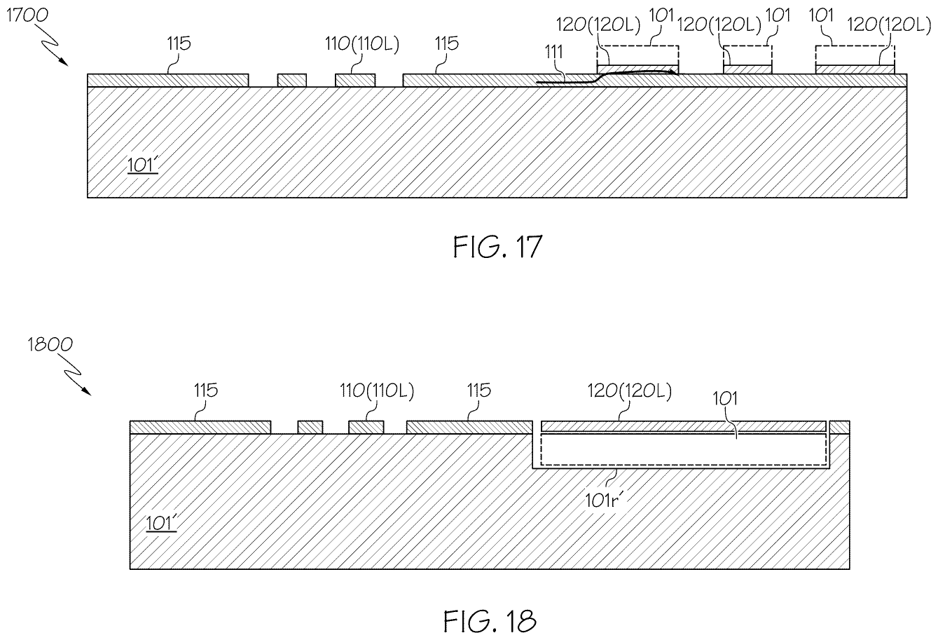

FIGS. 17 and 18 illustrate examples of providing nonlinear optical material(s) 120L with comparatively small surface areas on active device substrates 101′ of comparatively large surface areas, using evanescent coupling (i.e., by integration of the nonlinear optical element material 120L on a top surface of the active device substrate 101′), as shown in FIG. 17; and in-plane/edge coupling (i.e., by integration of the nonlinear optical element 120 into a recessed pocket 101r′ of the active device substrate 101′), as shown in FIG. 18.

In particular, as shown in FIG. 17, a method of forming a light source or PIC chip 1700 may be similar to that described with reference to FIG. 16, except that the native substrate 101 may not be entirely removed from the nonlinear optical element thin film 120L. Instead, the native substrate 101 may be thinned such that a thin layer of the substrate 101 remains as an upper cladding layer for the nonlinear optical element thin film 120L, and may be patterned along with the nonlinear optical element material 120L to provide physical support/structural stability and optical cladding for the nonlinear optical element material 120L.

Alternatively, as shown in FIG. 18, a method of forming a light source or PIC chip 1800 may be similar to that described with reference to FIG. 16, except that the active device substrate 101′ may be patterned to define recesses 101r′ or pits therein; and the nonlinear optical material layer 120L (including a portion of the underlying native substrate 101 thereof) may be bonded within the recesses 101r′ or pits and patterned (either before or after bonding) to define the nonlinear optical element 120, with edge coupling to the light emitting element 110 and/or waveguide elements 115.

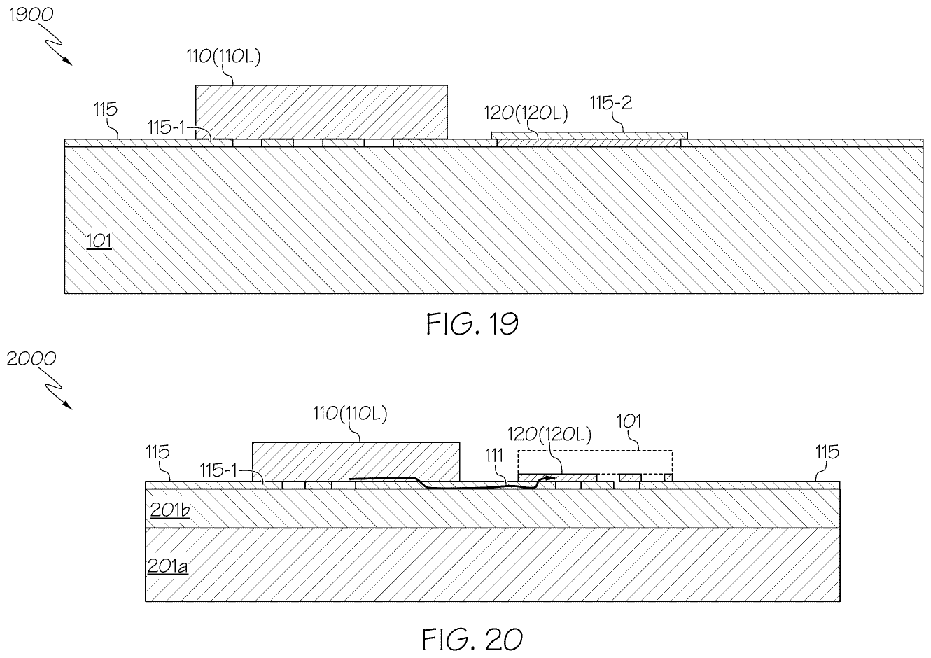

Still further embodiments of the present disclosure provide methods for integrating light emitting device materials 110L (e.g., III-V materials) onto a surface of a native substrate 101 (e.g., sapphire or engineered AlN) of a nonlinear optical element 120 (e.g., AlN), using micro-transfer printing techniques. As shown in FIG. 19, in a method of forming a light source or PIC chip 1900, a nonlinear optical material layer 120L (e.g., AlN) is formed (e.g., epitaxially grown) on a native substrate 101 (e.g., a sapphire substrate); waveguide element layers 115 (e.g., SiN or SiO or SiON layers) are deposited and patterned on the nonlinear optical element material 120L and the surface of the native substrate 101 for optical coupling; a light emitting element material 110L (e.g., a Group III-V material) is transfer printed onto the waveguide element layers 115; and patterning and metallization is performed to define the light emitting element 110 and the nonlinear optical element 120. Vertical couplers using tapers and/or evanescent coupling may be used to move light from one plane to another.

Advantages of transfer printing a light emitting element 110 (or material 110L thereof) onto the waveguide material layer 115 on a surface of the native growth substrate 101 of the nonlinear optical element 120 include the use of some conventional methods for directly integrating passive SiN/SiO/SiON and/or AlN waveguide features 115 with a III-V active light emitting element 110. On the other hand, such transfer printing methods may present challenges with respect to complications from wafer/substrate 101 processing (including potential thermal and optical impacts on processing and handling, respectively), providing heat sinking for the light emitting element 110 through the substrate 101 (which may require thinning of the substrate 101), and/or customization of the III-V stack 110L with release and/or lateral conduction layers for the transfer printing process.

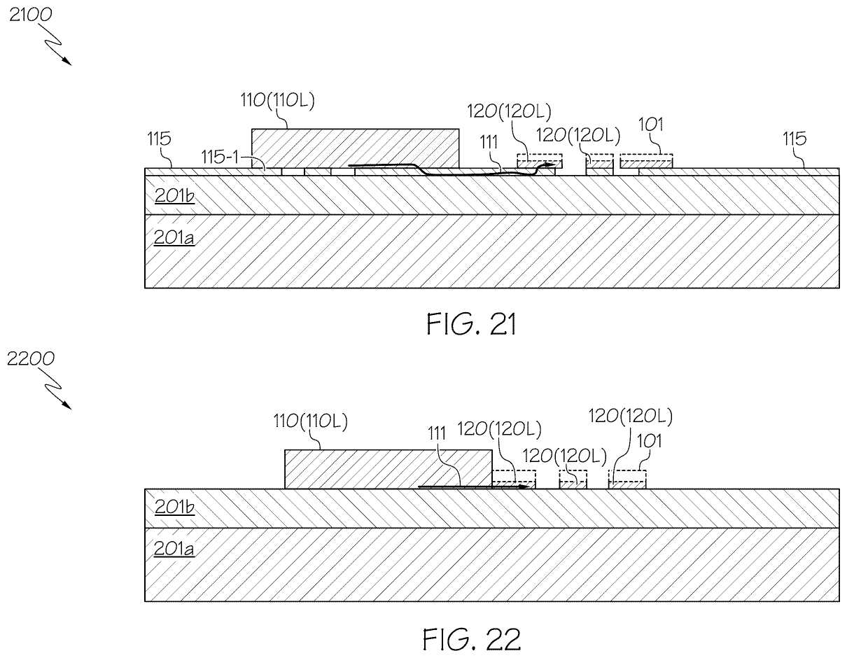

FIGS. 20, 21, and 22 illustrate methods of transfer printing both the light emitting element 110 and the nonlinear optical element 120 onto a non-native substrate 201. As shown in FIGS. 20-22, methods of forming light sources or PIC chips 2000, 2100, or 2200 include forming (e.g., epitaxially growing) a nonlinear optical material layer 120L (e.g., AlN) on a native substrate 101 (e.g., a sapphire substrate); (in some embodiments) depositing and patterning waveguide element layers 115 (e.g., SiN or SiO or SiON layers) on a surface of a non-native substrate 201 (e.g., a Si substrate 201a with a relatively thick SiO₂ layer 201b thereon) for optical coupling; transfer printing a light emitting element material 110L (e.g., a Group III-V material) and the nonlinear optical element material 120L (which may already be patterned with a thinned substrate 101 and singulated in some embodiments, as shown in FIGS. 21 and 22) onto the waveguide element layers 115 (for evanescent coupling of the light 111 emitted from the light emitting element 110 into the waveguides 115 and/or nonlinear optical element 120, as shown in FIGS. 20 and 21) and/or the surface of the non-native substrate 201 (for edge coupling of the light 111 emitted from the light emitting element 110 into the nonlinear optical elements 120 or waveguides, as shown in FIG. 22); and performing patterning and metallization of the light emitting element 110 material and/or the nonlinear optical element material 120L to provide the light emitting element 110 and the nonlinear optical element(s) 120 on the surface of the substrate 201.

Advantages of transfer printing the light emitting element 110 and the nonlinear optical element 120 (or material layers 110L and 120L thereof) onto the surface of a non-native substrate 201 include the use of some conventional methods for wafer/substrate 201 processing and/or directly integrating passive (e.g., SiN/SiO/SiON and/or AlN or other nonlinear optical material) waveguide features 115 with a (e.g., III-V material) active light emitting element 110, and ease of providing heat sinking for the light emitting element 110 to the substrate 201. On the other hand, such transfer-printing methods may present challenges with respect to thinning and singulation of the native growth substrate 101 (e.g., forming chiplets 101 with the nonlinear optical element material 120L thereon), and/or customization of the III-V stack 110L with release and/or lateral conduction layers for the transfer printing process.

Embodiments of the present disclosure may include (but are not limited to) one or more of the following technology elements, in various combinations: heterogeneous integration of active 110 and passive optical elements 120; waveguides 115, including AlN-based waveguides 115 or PICs; wavelength conversion (e.g., SHG/SFG) using nonlinear optical elements 120 (e.g., AlN-based or other materials); optically resonant microcavities 125 (resonant cavity enhancement); selective outcoupling of far-UVC wavelengths 121, with light output that is partially free of the light 111 of the fundamental wavelength of the light emitting element 110; and distributed light emission over one or more dimension of the nonlinear optical elements 120.

While described herein primarily with reference to AlN-based nonlinear optical elements 120 (including resonators and waveguides 115), it will be understood that embodiments of the present disclosure are not limited to the use of AlN, and may include any nonlinear optical material 120L that is transparent down to wavelengths of about 200 nm (i.e., over the UVC or far-UVC wavelength range). Additional examples of nonlinear optical materials 120L that may be used in any of the embodiments described herein may include, but are not limited to, AlScN, AlN, AlGaN. Also, while described herein primarily with reference to integration of light emitting material layers or stacks 110L, embodiments of the present disclosure may include integration of the light emitting materials 110L or light emitting elements 110 formed from the light emitting material layers 110L. Embodiments of the present disclosure may also include combinations of edge and evanescent coupling of the optical signals, may be free of air gaps between active and passive devices, and may utilize various methods of forming the nonlinear optical materials (e.g., high quality AlN by MOCVD, or low quality AlN by sputtering, etc.).

As described herein, some embodiments may utilize the above and/or other methods to fabricate intracavity structures, in which the passive nonlinear optical material or element 120 is integrated into the optical cavity 105 of (and thus, can be considered as part of) the active light emitting element 110. In contrast, in external cavity structures, the material for the active (e.g., III-V) light emitting device may be added to a passive host material (e.g., silicon or silicon nitride), where the host material (Si, SiN) is not part of the active light emitting device, but rather receives light therefrom. In some embodiments, the nonlinear optical material 120L may be selected such that the waveguide 115 into which it is integrated and the light emitting material 110L may be formed from a common material system (e.g., AlGaN and InAlGaN).

Also, higher temperature process steps may be used in forming certain materials (e.g. AlN 120L and/or III-V layer stack 110L), which may be incompatible with other waveguide materials (e.g., SiN). By performing heterogeneous integration operations after the high temperature steps, higher quality materials can be realized without compromising the other materials. In addition, integration of the native substrate material 101, 101′ may differ from some conventional processes (e.g., micro-transfer printing, which typically relies on removal of the epitaxially grown layers from the underlying native substrate).

As described herein, the laser or other light emitting element represents an “active” device or element insofar as it converts electrical power into optical power (electrons into photons). The nonlinear crystal or other optical element used for SFG (such as SHG) represents a “passive” device or element insofar as it does not receive electrical inputs (but rather, receives and outputs photons). Heterogeneous integration of active light sources and passive nonlinear optical elements for operation at UV wavelengths may provide higher performance (e.g., low optical loss between active and passive elements, and matching of resonant frequencies for (active) pump and (passive) conversion device) with lower cost at volume (e.g., using relatively small area devices, and wafer processing operations that may be compatible with existing compound semiconductor industry).

Based on some challenges for SHG described above, embodiments of the present disclosure may further integrate the material platforms of the active and passive devices so as to provide a solid state chip in which light is guided from the active device to the passive device all within an integrated circuit on a single chip (also referred to as a PIC chip) that contains both the active and passive devices (which in some embodiments are formed from different materials). Processes that allow integration of an active device with passive photonic devices made from different materials (e.g., originally fabricated on respective native substrates) to be brought together to form a single chip are referred to herein as heterogeneous integration (HI) processes.

Some heterogeneous integration processes as described herein may involve die bonding, flip-chip bonding (including gain chip bonding), wafer bonding, micro transfer printing, and other pick/place approaches that bring a given solid state material into contact with another and form covalent, ionic van der Waals, or other form of chemical or electrostatic bond between the materials. In some embodiments, the HI processes may integrate a largely completed device (having predefined critical features), or may integrate incomplete devices in some raw or incomplete form for further subsequent processing (including substantial subsequent fabrication processes).

Commercial applications in accordance with embodiments of the present disclosure can include elimination of pathogens from air and/or surfaces in any indoor spaces where humans congregate (e.g., airports, schools, hospitals, inpatient care centers, workplaces, etc.), as well as in transportation vehicles (e.g., subway cars, trains, taxis, airplanes) and agricultural settings (e.g., animal production facilities, meatpacking facilities, indoor greenhouses, etc.) as well as in the purification of water.

Various embodiments have been described herein with reference to the accompanying drawings in which example embodiments are shown. These embodiments may, however, be embodied in different forms and should not be construed as limited to the embodiments set forth herein. Rather, these embodiments are provided so that this disclosure is thorough and complete and fully conveys the inventive concept to those skilled in the art. Various modifications to the example embodiments and the generic principles and features described herein will be readily apparent. In the drawings, the sizes and relative sizes of layers and regions are not shown to scale, and in some instances may be exaggerated for clarity.

The example embodiments are mainly described in terms of particular methods and devices provided in particular implementations. However, the methods and devices may operate effectively in other implementations. Phrases such as “example embodiment”, “one embodiment” and “another embodiment” may refer to the same or different embodiments as well as to multiple embodiments. The embodiments will be described with respect to systems and/or devices having certain components. However, the systems and/or devices may include fewer or additional components than those shown, and variations in the arrangement and type of the components may be made without departing from the scope of the inventive concepts.

The example embodiments will also be described in the context of particular methods having certain steps or operations. However, the methods and devices may operate effectively for other methods having different and/or additional steps/operations and steps/operations in different orders that are not inconsistent with the example embodiments. Thus, the present inventive concepts are not intended to be limited to the embodiments shown, but are to be accorded the widest scope consistent with the principles and features described herein.

It will be understood that when an element is referred to or illustrated as being “on,” “connected,” or “coupled” to another element, it can be directly on, connected, or coupled to the other element, or intervening elements may be present. In contrast, when an element is referred to as being “directly on,” “directly connected,” or “directly coupled” to another element, there are no intervening elements present.

It will also be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompass both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

The terminology used in the description of the disclosure herein is for the purpose of describing particular embodiments only and is not intended to be limiting of the disclosure. As used in the description of the disclosure and the appended claims, the singular forms “a”, “an” and “the” are intended to include the plural forms as well, unless the context clearly indicates otherwise.

It will also be understood that the term “and/or” as used herein refers to and encompasses any and all possible combinations of one or more of the associated listed items. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to illustrations that are schematic illustrations of idealized embodiments (and intermediate structures) of the disclosure. As such, variations from the shapes of the illustrations as a result, for example, of manufacturing techniques and/or tolerances, are to be expected. Thus, the regions illustrated in the figures are schematic in nature and their shapes are not intended to illustrate the actual shape of a region of a device and are not intended to limit the scope of the disclosure.

Unless otherwise defined, all terms used in disclosing embodiments of the disclosure, including technical and scientific terms, have the same meaning as commonly understood by one of ordinary skill in the art to which this disclosure belongs, and are not necessarily limited to the specific definitions known at the time of the present disclosure being described. Accordingly, these terms can include equivalent terms that are created after such time. It will be further understood that terms, such as those defined in commonly used dictionaries, should be interpreted as having a meaning that is consistent with their meaning in the present specification and in the context of the relevant art and will not be interpreted in an idealized or overly formal sense unless expressly so defined herein. All publications, patent applications, patents, and other references mentioned herein are incorporated by reference in their entireties.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments of the present disclosure described herein, and of the manner and process of making and using them, and shall support claims to any such combination or subcombination.

Although described herein with reference to various embodiments, it will be appreciated that further variations and modifications may be made within the scope and spirit of the principles of the disclosure. Although specific terms are employed, they are used in a generic and descriptive sense only and not for purposes of limitation, with the scope of the present invention set forth in the following claims.

Claims:

1. A light source, comprising:
a substrate;
a light emitting element comprising a first semiconductor material on the substrate, wherein the light emitting element is configured to generate light of a first frequency; and
a nonlinear optical element comprising a second semiconductor material on the substrate, wherein the nonlinear optical element is configured to receive the light of the first frequency from the light emitting element and generate light of a second frequency,
wherein the second semiconductor material is different from the first semiconductor material, and wherein the substrate is native to one of the first semiconductor material or the second semiconductor material.

2. The light source of claim 1, further comprising:
a waveguide element comprising a material different than the first semiconductor material on a surface of the substrate, wherein the waveguide element optically couples the light emitting element to the nonlinear optical element.

3. The light source of claim 2, wherein the nonlinear optical element comprises one or more epitaxial layers of the second semiconductor material on the surface of the substrate.

4. The light source of claim 3, wherein the substrate comprises a recess therein, wherein the light emitting element is in the recess, and wherein the waveguide element is on the surface of the substrate outside the recess.

5. The light source of claim 4, wherein the substrate is a first substrate, and further comprising:
a second substrate having the first substrate stacked thereon, wherein the recess extends through the first substrate to expose a portion of the second substrate, and the light emitting element is on the portion of the second substrate exposed by the recess.

6. The light source of claim 3, wherein first portions of the waveguide element are between the light emitting element and the surface of the substrate in a vertical direction.

7. The light source of claim 6, wherein the nonlinear optical element is between second portions of the waveguide element and the surface of the substrate in the vertical direction.

8. The light source of claim 6, wherein the first portions of the waveguide element comprise one or more epitaxial layers of the second semiconductor material.

9. The light source of claim 2, wherein the waveguide element comprises a material that is different from the second semiconductor material and is transparent to the light of the second frequency.

10. The light source of claim 2, wherein the light emitting element comprises one or more epitaxial layers of the first semiconductor material on the surface of the substrate.

11. The light source of claim 10, wherein one or more portions of the waveguide element are between the nonlinear optical element and the surface of the substrate.

12. The light source of claim 11, wherein the nonlinear optical element comprises one or more epitaxial layers of the second semiconductor material on at least a portion of a growth substrate.

13. The light source of claim 12, wherein the substrate comprises a recess therein, and wherein the at least a portion of the growth substrate is in the recess.

14. The light source of claim 2, wherein the waveguide element is configured for light propagation in a first plane that differs from a second plane of light propagation in the light emitting element or the nonlinear optical element, and further comprising:
one or more tapered optical elements configured to direct the light of the first frequency or the light of the second frequency between the first plane and the second plane.

15. The light source of claim 1, wherein the light emitting element is a laser diode comprising a lasing cavity, and wherein the nonlinear optical element comprises a resonant cavity that is optically coupled to the lasing cavity.

16. A light source, comprising:
a substrate;
a laser diode comprising a first semiconductor material on the substrate, wherein the laser diode comprises a lasing cavity and is configured to generate light of a first frequency;
a waveguide element comprising a material different from the first semiconductor material on the substrate, wherein the waveguide element is at least partially between first and second ends of the lasing cavity and is configured to receive the light of the first frequency from the laser diode; and
a nonlinear optical element comprising a second semiconductor material different from the first semiconductor material on the substrate, wherein the nonlinear optical element comprises a resonant cavity that is optically coupled between the first and second ends of the lasing cavity and is configured to receive the light of the first frequency from the waveguide element and generate light of a second frequency.

17. The light source of claim 16, wherein the waveguide element comprises respective reflector elements at the first and second ends of the lasing cavity, and wherein the nonlinear optical element comprises a closed-loop element comprising the resonant cavity.

18. The light source of claim 17, wherein the laser diode is configured to emit the light of the first frequency in a first propagation direction that is different from a plane of extension of the waveguide element, and further comprising:
a diffraction grating that is configured to alter the first propagation direction of the light of the first frequency into a second propagation direction along the plane of the waveguide element.

19. The light source of claim 16, further comprising:
a phase tuning element in the lasing cavity and configured to alter an index of refraction of the waveguide element.

20. The light source of claim 16, wherein the substrate is native to one of the first semiconductor material or the second semiconductor material.

21. A method of fabricating a semiconductor light source, the method comprising:
providing a substrate;
providing a light emitting element comprising a first semiconductor material on the substrate, wherein the light emitting element is configured to generate light of a first frequency; and
providing a nonlinear optical element comprising a second semiconductor material on the substrate, wherein the nonlinear optical element is configured to receive the light of the first frequency from the light emitting element and generate light of a second frequency,
wherein the second semiconductor material is different from the first semiconductor material, and wherein the substrate is native to one of the first semiconductor material or the second semiconductor material.

22. The method of claim 21, further comprising:
providing a waveguide element material, which is different than the first semiconductor material, on a surface of the substrate; and
patterning the waveguide element material to form a waveguide element on the surface of the substrate, wherein the waveguide element optically couples the light emitting element to the nonlinear optical element.

23. The method of claim 22, wherein providing the nonlinear optical element comprises:
epitaxially growing the second semiconductor material on the surface of the substrate; and
patterning the second semiconductor material to form the nonlinear optical element on the surface of the substrate.

24. The method of claim 23, wherein providing the light emitting element on the substrate comprises:
patterning the substrate to form a recess therein; and
providing the light emitting element in the recess,
wherein the waveguide element and the nonlinear optical element are on the surface of the substrate outside the recess.

25. The method of claim 24, wherein providing the light emitting element in the recess and providing the nonlinear optical element comprises:
bonding the first semiconductor material in the recess; and
patterning the first semiconductor material and the second semiconductor material to define the light emitting element in the recess and the nonlinear optical element on the surface of the substrate outside the recess.

26. The method of claim 24, wherein the substrate is a first substrate, and wherein providing the light emitting element in the recess comprises:
thinning the first substrate;
bonding second substrate to the first substrate responsive to the thinning, wherein the recess extends through the first substrate to expose a portion of the second substrate; and
providing the light emitting element on the portion of the second substrate exposed by the recess.

27. The method of claim 23, wherein the light emitting element is provided on one or more portions of the waveguide element such that the one or more portions of the waveguide element are between the light emitting element and the surface of the substrate in a vertical direction.

28. The method of claim 27, wherein the one or more portions of the waveguide element comprise one or more epitaxial layers of the second semiconductor material.

29. The method of claim 22, wherein the waveguide element material is different from the second semiconductor material and is transparent to the light of the second frequency.

30. The method of claim 22, wherein providing the light emitting element comprises:
transfer printing the first semiconductor material onto the waveguide element.

31. The method of claim 22, wherein providing the light emitting element comprises:
epitaxially growing the first semiconductor material on a surface of the substrate; and
patterning the first semiconductor material to form the light emitting element on the surface of the substrate.

32. The method of claim 31, wherein the substrate is a first substrate, and wherein providing the nonlinear optical element comprises:
epitaxially growing the second semiconductor material on a second substrate; and
bonding the second substrate to the first substrate.

33. The method of claim 32, wherein providing the nonlinear optical element further comprises:
at least partially removing the second substrate after the bonding to the first substrate; and
patterning the second semiconductor material to form the nonlinear optical element on one or more portions of the waveguide element.

34. The method of claim 32, wherein providing the nonlinear optical element comprises:
patterning the first substrate to form a recess therein; and
bonding the second substrate including the second semiconductor material thereon in the recess in the first substrate,
wherein the waveguide element is on the surface of the first substrate outside the recess.

35. The method of claim 22, wherein the light emitting element is a laser diode comprising a lasing cavity, and wherein the nonlinear optical element comprises a resonant cavity that is optically coupled to the lasing cavity.

36. The method of claim 35, wherein providing the waveguide element comprises:
forming respective reflector elements at the first and second ends of the lasing cavity,
wherein the nonlinear optical element comprises a closed-loop element comprising the resonant cavity.

37. The method of claim 36, wherein the laser diode is configured to emit the light of the first frequency in a first propagation direction that is different from a plane of extension of the waveguide element, and further comprising:
providing a diffraction grating in or on the waveguide element, wherein the diffraction grating is configured to alter the first propagation direction of the light of the first frequency into a second propagation direction along the plane of the waveguide element.

38. The method of claim 35, further comprising:
providing a phase tuning element in the lasing cavity and configured to alter an index of refraction of the waveguide element.

39. The method of claim 22, wherein the waveguide element is configured for light propagation in a first plane that differs from a second plane of light propagation in the light emitting element or the nonlinear optical element, the method further comprising:
providing one or more tapered optical elements configured to direct the light of the first frequency or the light of the second frequency between the first plane and the second plane.

40. The method of claim 21, wherein the second semiconductor material comprises aluminum nitride (AlN), and the first semiconductor material comprises a Group III nitride.
